(19) United States
(12) Patent Application Publication
(10) Pub. No.: US 2010/0153848 A1
(43) Pub. Date: Jun. 17, 2010

(54) INTEGRATED BRANDING, SOCIAL BOOKMARKING, AND AGGREGATION SYSTEM FOR MEDIA CONTENT

(76) Inventor: Pinaki Saha, Chicago, IL (US)

Correspondence Address: OVERHAUSER & LINDMAN, 740 W. GREEN MEADOWS DRIVE, SUITE 300, GREENFIELD, IN, 46140, US

(21) Appl. No.: 12/577,151

(22) Filed: Oct. 9, 2009

Related U.S. Application Data
(60) Provisional application No. 61/104,234, filed on Oct. 9, 2008.

(51) Int. Cl. G06F 3/00; G06F 17/30; G06F 15/16

(52) U.S. Cl. 715/721; 709/203; 709/219

(57) ABSTRACT

A system enables user generated content (UGC) and data (collectively metadata) to be associated with playable media content in a GUI. A skin (metadata and GUI) overlays the media content and includes a set of markers associated with the selected media content, the markers with at least one of an elapsed time and a frame of the selected playable media content and including metatags relevant to the content of the media at the elapsed time or frame. The system includes a social networking and sharing platform and provides layers of meta-information that can be added, deleted, or edited without altering the original content. The system enables the tagging of objects within content and allows these objects to be matched to any category of interest, and allows sharing of such tags. The system enables ‘search & discovery’ by sorting and matching labels (e.g., title & description) and works with still image media, audio, or video.

### CROSS-REFERENCE TO RELATED APPLICATIONS

This application is a nonprovisional of and claims the benefit of U.S. Patent Application No. 61/104,234, filed Oct. 9, 2008, and titled Integrated Branding, Social Bookmarking, and Aggregation System for Media Content, which is incorporated herein by reference.

### COPYRIGHT NOTICE

A portion of the disclosure of this patent document contains material which is subject to copyright protection. The applicant has no objection to the facsimile reproduction by anyone of the patent disclosure, as it appears in the US Patent and Trademark Office files or records, but otherwise reserves all applicant's copyrights whatsoever.

### BACKGROUND

The present invention relates to a system for organizing and sharing information via the Internet, and particularly, to a system for associating additional information content with playable media content.

Today's conventional media content is flat and unidirectional. There is no ‘in-place’ tool or medium where viewers can gather or share information, or enrich their social network experience while viewing, for example, a movie, a news feed, a sporting event or a music video. Furthermore, there is no way to associate and display information with this content or to share such pieces of information with their friends and families.

In an ever growing world of millions of videos it is frustrating for the consumer to look for media content based information that is exactly what that individual consumer wants. The world is all about information. But information is only valuable if it addresses the individual consumer's interest at the time that the consumer has an interest.

Among consumers worldwide, there is a mega-trend where the traditional television set is increasingly being regarded as just one option among several for consuming video content, as the boundaries between the TV and devices such as the mobile handset and PC become more blurred by the day. As this shift in consumption behaviors accelerates in momentum, another massive wave of change is occurring—one that will ultimately transform the content production and distribution marketplace worldwide.

There is a simultaneous global mega-trend: User-generated content is in tremendous demand across the generations, with half of all consumers watching and/or reading content created by others. And, while Millennials are at the forefront of this trend, X-ers, Boomers and Matures are also participating at record levels including visits to video sharing sites, watching/reading personal content created by others, watching video streaming sites, and consumers are creating their own entertainment, such as editing movies, music and photos.

A third important global mega-trend, only a few years ago, skeptics were convinced people wouldn't be interested in all-in-one handhelds, or in paying for media services. They were wrong. Cell phones are surging as entertainment devices and as well . . . everything devices. Here too, Millennials lead the way.

TV, Internet, cell phones and digital media advertising must co-exist in an environment where the total amount of advertising dollars is growing at 3-5% per year. Content developers are seeking ways to monetize their assets in the medium and across long tail. Advertisers are faced with the problem of how to efficiently reach and monetize audiences for their products and services. Content owners are actively seeking ways to efficiently engage consumers in their visual brands in order to monetize audiences and visual content.

### SUMMARY

The presently disclosed innovative system extends beyond the existing ways of creating, consuming and adding to dynamic or playable media content (for example, audio/video or still content or audio) and incorporating brand content. The disclosed system enables the breaking of media content into infinite points of contextual information on an individualized basis according to the interests of the consumer, benefit of the brand, and profit of the media creator. The system is not simply an application, it is an enabler, enhancer and accelerator, capitalizing on the tools, for example of Web 2.0, to make the media experience shareable and grow-able, thus providing beneficial advantages for consumers, brands and media creators. Functionality facilitates information finding, absorption, sharing, and building. For example, the innovative system allows information seeking right from the media content without modification of the media source file. Thus, the system compresses the time and effort to get to “I FOUND IT.”

The system opens an extra dimension to the existing two dimensional story (time and location) by building vertical layers of information accessible by a single mouse click. The system, with its unique set of functional attributes, empowers the viewer to interact with the story and build extra knowledge bases around the content. For example, when a user watches two characters eating a meal in a diner in a movie, for example, George Clooney and Brad Pitt in Oceans Eleven, the application enables the user to learn the location of the restaurant, a similar restaurant close to the user, the menu card, the cookbooks offered by the celebrity chef, that day's menu, patron reviews, and make a reservation from an online portal. Additionally, the system enables users to meet and converse with people with like interests, for example, who have been to that restaurant or others like it. The system can also enable users to find embedded links to videos on how to cook certain dishes, wine reviews and content on how to pick certain wines with certain foods, access a VIP coupon good for a free appetizer or round of drinks on the first visit, the ability to take a virtual tour of the casino in which the restaurant is housed, learn the history of the entertainment business in Las Vegas, etc.

The appended and relevant content associated by the system to a particular scene or other portion of media content is virtually limitless, as one bit of information relating to the content allows the user to link to or experience something or someone else. The system leverages the huge resources delivered via the Internet today by attaching relevant pieces of information from it right into the media playback interface. This bridge opens up a tremendous potential of multidimensional interactivity with the previously unidirectional media.

The system also enables users to have the ability to place their own content, as well as inserting themselves in that scene by adding content to the system experience. Following the restaurant example, users may choose to upload information about restaurants that specialize in that type of cuisine (e.g. French). A user might upload her opinion of a French restaurant that is nestled in the midst of Napa Valley. She might also share her favorite dishes and comment on that restaurant's specialty. She might also choose to add a link to a cookbook, links to cooking classes sponsored in San Francisco, etc. Additionally, the user might also upload the best bed and breakfasts to stay at while in Napa Valley, a tip to visit a particular winery, and a particular wine to try, which is indicated to be excellent but hard to find. Since it is hard to find, the user could upload links to supplier's website that sells the wine.

The system also has a commercial application that functions along side the user-specific functionality described above A media playing interface also gives brands a tremendous opportunity to hyper-target message delivery by identifying and categorizing users through collective analytics. This is accomplished by allowing brands to embed brand-specific metadata to the content either at the content's creation or after the fact. For an example of how this would work, consider the Ocean's Eleven movie mentioned above.

One of the series of Ocean movies spotlights a particular automobile, the Mini Cooper. With the presently disclosed system, BMW could embed a host of metadata on the Mini Cooper. For example, the metadata could include a history of the Mini, a virtual test drive, a free downloadable music play list, dealer locations, consumer road test findings, a widget to set a test drive in which you get a $25 gas card, dealer locater, and a print on demand coupon for an additional $1,000 off the sticker price. This content can then be further added to users as described in the restaurant example above.

All of this additive content is facilitated by a GUI associated with the system called a “Skin”. This Skin can be a separate application and/or display area that overlays the media content, or can be incorporated into other applications. The skin is seen through a system Reader and can be created or added to using a system Writer, for example that is functionality embedded into the reader.

According to the above examples, the presently disclosed system allows the brand to be integrated into the media experience where consumers find their exposure to the brand to be of greatest interest. The system matches brands to the experience within the media—not just around the media—which puts the brand closer to the time of consumer interest since the consumers themselves have defined for themselves the most personally compelling parts of the experience. This provides consumer driven ad consumption vs. brand driven consumer consumption.

The presently disclosed system and the claims may comprise one or more of the following features and combinations thereof.

One illustrative embodiment includes a GUI for synchronizing the display of producer or user generated content (collectively UGC or, the “skin”) with playable media content, including meta data associated with a playable media file, each meta data file identifying an associated playable media file, each meta data file having at least one marker identifying a contiguous subset of the playable media file, at least one meta-tag associated with each at least one marker, and each at least one metatag including information relating to the contiguous subset of the playable media file.

The illustrative GUI, wherein each marker includes at least a start point and end point, start point and time duration, and/or start point and number of video frames. Each metatag includes a “snippet” of content identified by the marker and from the playable media file. Each meta data includes a wiki on/off indicator. The meta data can also include contact information to obtain information regarding intellectual property rights associated with the media content associated with the data file, for example, an email address or a URL.

In the illustrative GUI, each marker includes a wiki on/off indicator. Each marker contains at least one searchable label. Each metatag includes a wiki on/wiki off indicator. Each metatag includes contact information to obtain information regarding intellectual property rights associated with the metatag. Each metatag includes at least one searchable label. Metatag information includes one of media content, opinion or comment, factual information, promotional information, or URL link. Each metatag associated with more than one of the plurality of meta data. For the purposes of this disclosure, a metatag is not limited to HTML, XHTML, or data relating to a webpage.

Another illustrative embodiment includes a processor executable module for playable media content and user generated content (UGC) that is adapted to associate playable media content with a set (a skin) of UGC features (metatags), adapted to synchronize the display of the metatag features with the playing of the media content based on each metatag feature being associated with a particular segment of the media content, and includes play controls (for example, play, pause, forward, reverse, etc.) and a display area providing available metatag features during play of the media content, the available metatag features based at least in part on the segment of the media content with which each metatag feature is associated.

The illustrative processor executable module for playable media content and metatags is adapted to store information about the selection and to transmit the information to another computer, for example in response to a user selecting one of the plurality of available metatags. The information transmitted includes at least one of an indicator of the identity of the person selecting the metatags, the time the metatag is selected, an identification of the set of metatag features from which the metatag was selected, an identification of the media content associated with the skin, and information about the state of viewer settings of the player and associated consoles at the time when the user selected a metatag.

The illustrative processor executable module, wherein the available metatag features are based at least in part on a viewer's preference settings. The display area includes an available subset of metatag features associated with the presently playing segment of the media content, an available subset of metatag features associated with a prior played segment of the media content, and/or an available subset of metatag features associated with an upcoming segment of the media content. The segments each defined by a marker associated with at least one of elapsed time and frame of the media content, and each metatag feature is associated with a marker adapted to create, share, search, save, copy, add-in to, and/or rate a metatag feature.

Yet another illustrative embodiment includes a processor executable module for creating user generated content (UGC) relating to playable media content and for later serving by a server that is adapted to select a playable media content file, adapted to define a set of markers on a skin associated with the selected media content, the set of markers including at least one marker, adapted to associate each of the markers with at least one of an elapsed time and a frame of the selected playable media content, adapted to define at least one UGC feature (metatag) with each marker, the metatag feature being relevant to the content of the media beginning at the elapsed time or frame marked by the marker, and adapted to upload at least one marker and at least one metatag to the server.

The illustrative processor executable marker for creating metatag, wherein the set of markers includes contact information to obtain information regarding intellectual property rights associated with the selected media content. Adapted to receive confirmation from the user defining the set of markers whether or not the user holds sufficient intellectual property rights in the selected media content. Adapted to specify wiki on/off for each marker or each set of markers. Adapted to specify wiki on/off for each metatag feature. Adapted to capture and store in a server a very small segment of content beginning from the position of a marker as a thumbnail or preview. Adapted to receive confirmation from the user defining a metatag feature that the user holds sufficient intellectual property rights in the metatag feature. Limitations on the number of markers associated with a media content file and/or the duration of each marker. Adapted to copy a marker or a metatag feature from one set of markers to another set of markers dependent on wiki on/off settings for the source of the copy.

An illustrative embodiment includes a database server including a plurality of marker sets wherein each marker set includes at least one marker, each marker set associated with a specific media content file accessible via the Internet, a plurality of metatag features, each metatag feature associated with at least one marker, means for receiving a request from a client computer, means for transmitting a marker set to the client in response to the request, and means for receiving and recording information about the metatag features selected at the client computer.

The illustrative database server, wherein the request includes a specified media content file and further including a means for selecting one of the plurality of marker sets that are associated with the specified media content file. The request including a specified marker set and further including transmitting to the client a URL associated with the specified media content file. Wiki settings associated with each marker set, marker, and metatag feature. The server adapted to facilitate sharing, searching, copying, saving, and add-in by users; and to record information, including rankings, of metatag features by users. Recorded information including identification of each marker set in which the metatag feature exists, and for each such metatag feature/marker set combination: number of views, number of references, times forwarded, rankings, and the like.

An illustrative method of displaying enhanced content (or skin) in coordination with playable media content, for example, associated with the illustrative processor executable module for playable media content and metatag, includes the steps of selecting a media content identifier, receiving a transmission (e.g., download or streaming) of the media content, receiving a transmission (e.g., download or streaming) of enhanced content associated with the media content, and automatically displaying the availability of one or more metatags within the enhanced content for selection by the user at times associated with a subset of the media content. If a metatag is selected, the steps of displaying the metatag's content and transmitting to a remote computer information regarding the selection of the metatag.

Another illustrative method of displaying enhanced content (or skin) in coordination with playable media content, for example, associated with the illustrative database server, includes the steps of receiving an identification of an enhanced skin from a user, retrieving all markers and metatag features associated with the skin sought by the user from the database server, and transmitting the skin and associated markers and metatags to the user.

An illustrative method associated with the illustrative database server and for collecting consumer behaviors, includes the steps of maintaining a first database indexing playable media content, each media content associated with at least one marker set, each marker set including at least one marker associated with an elapsed time or frame of the media content, and each marker associated with at least one metatag feature; and receiving metatag feature selection information from a remote computer, the metatag feature selection information including a unique marker set identifier and a unique metatag feature identifier. The step of recording in a second database information about the selection of the metatag features. The step of generating reports regarding the selection of metatags. The selection information including user information, for example, email address, user name, and date/time of metatag feature selection; media content information, for example, title and scene with which metatag feature is associated (e.g., time code or/and frame number); metatag feature hierarchy information; number of total views; number of views over last 24 hours; number of forwards; number of user who saved the tag in the favorites folder; metatag feature ratings; and search labels/categories under which tag has been imported.

Additional features of the disclosure will become apparent to those skilled in the art upon consideration of the following drawings and detailed description of the illustrative embodiments.

### BRIEF DESCRIPTION OF THE DRAWINGS

The detailed description particularly refers to the accompanying figures in which:

FIG. 1A shown an illustrate embodiment of a system for displaying media content and information/metadata associated additive content;

FIG. 1B shows an illustrative conceptual embodiment of a browser-style Reader portion of the system of FIG. 1 for displaying media content with an associated GUI and additive content, collectively referred to as a “Skin”;

FIG. 2 illustrates conceptually a set of markers associated with specific portions of or objects of media content, and information/metadata associated with the markers;

FIG. 3 shows an illustrative software engine for the Reader portion of the system;

FIG. 4 shows an illustrative embodiment of a browser portion of the system, and in particular a Portfolio of Skins;

FIG. 5A shows the Favorites listing of My Skins for the browser portion of the system of FIG. 4;

FIG. 5B shows the Favorites listing of My Markers for the browser portion of the system of FIG. 4;

FIG. 5C shows the Favorites listing of My Tags for the browser portion of the system of FIG. 4;

FIG. 6A shows an illustrative embodiment of the Screen of the browser portion of the system, and in particular, display of metadata associated with media content;

FIG. 6B shows an illustrative embodiment of the Screen of FIG. 6A with a scene being shared;

FIG. 6C shows an illustrative embodiment of the Screen of FIG. 6A with a marker being suggested;

FIGS. 7A-7C show an illustrative embodiment of a browser portion of the system, and in particular the user Account Info;

FIG. 8 shows an illustrative embodiment of the Social Network of the browser portion of the system;

FIG. 9 shows an illustrative embodiment of a software engine for the Author portion of the system;

FIG. 10 shows an illustrative embodiment of a browser associated with the Author engine of FIG. 9;

FIG. 11 illustrates the searching an importing of a pre-existing metatag using the Author engine of FIG. 9;

FIG. 12A shows an illustrative embodiment of a browser associated with the Author engine of FIG. 9, and in particular, a Skin creation task;

FIG. 12B shows an illustrative embodiment of a browser associated with the Author engine of FIG. 9, and in particular, a Marker creation task;

FIG. 12C shows an illustrative embodiment of a browser associated with the Author engine of FIG. 9, and in particular, a Tag creation task;

FIG. 12D shows an illustrative embodiment of a browser associated with the Author engine of FIG. 9, and in particular, a Object creation task;

FIG. 13 shows an illustrative data structure of tables and fields associated with the system and contained in the system database;

FIG. 14 shows an illustrative presentation of analytics information associated with the system;

FIG. 15 shows a first illustrative system portal;

FIG. 16 shows a second illustrative system portal;

FIG. 17 shows an illustrative algorithm for viewing a Skin using the system; and

FIG. 18 shows an illustrative algorithm for authoring a Skin using the system.

### DESCRIPTION OF THE ILLUSTRATIVE EMBODIMENTS

For the purposes of promoting and understanding the principals of the invention, reference will now be made to one or more illustrative embodiments shown in the drawings and specific language will be used to describe the same.

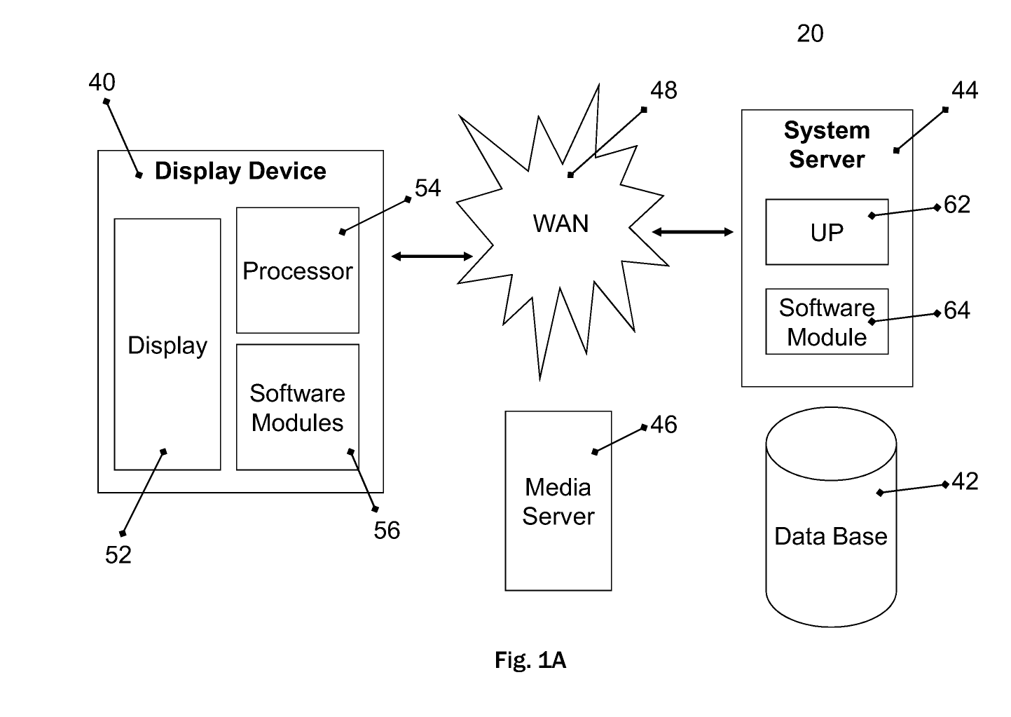

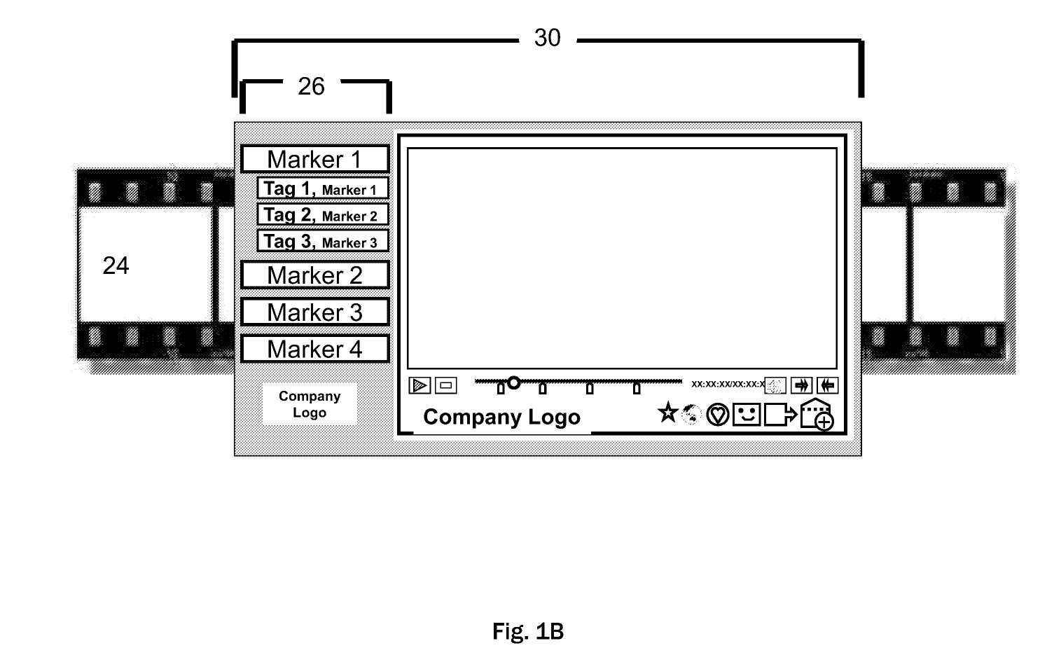

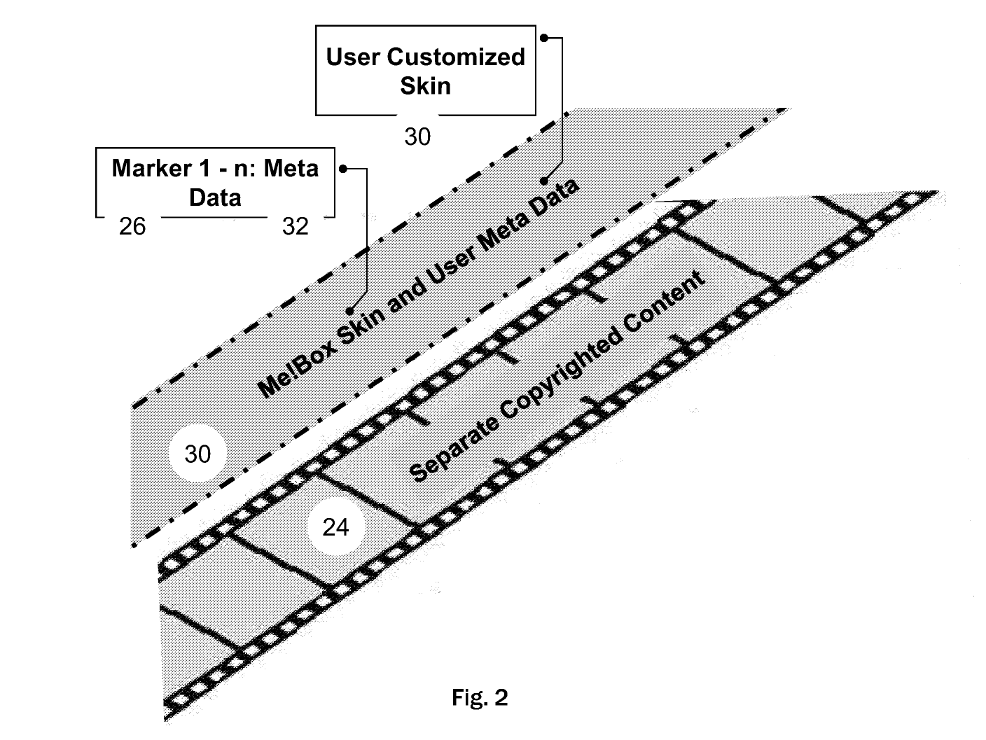

Referring to FIGS. 1A, 1B, and 2, an illustrative embodiment of a system 20 comprises hardware and software modules that provide a platform of bi-directional interactivity around audio and video media content 24. The system 20 enables additive content such as user generated content (UGC), including markers 26, to be associated and displayed with playable media content 24 in a GUI, such as the browser-style interface 28. A Skin (UGC and GUI) 30 overlays the media content 24 and includes a set of markers 26 associated with the selected media content, the markers identifying a contiguous subset of the media content, for example, an elapsed time, a frame, or a portion of a frame, such as a displayed object, of the selected playable media content 24. The markers 26 are also associated with one or more metatags 32 relevant to the content of the media at the elapsed time, frame, and/or object.

Referring to FIG. 1A, the illustrative embodiment of the system 20, includes a display device 40, a database 42, a system server 44, a media server 46, and a communications network 48, for example a WAN such as the internet, connecting the display device 40 and servers 44 and 46 for communication. The display device 40 can be a computer, a handheld device, or other devices known in the art having a visual display 52, programmable processor 54, and software module(s) 56 enabling the browser-type interface 28 on the display device 40. The system server 44 includes a programmable processor 62 and software module(s) 64 providing communication with and other functions relating to database 42, which stores the metadata associated with the skins 30, markers 26, and metatags 32. The media content server(s) 46 provide storage and serving of the playable media content 24 with which the metadata is associated and displayed on display device 40.

The system 20 can include a social networking and sharing platform and provides layers of meta-information that can be added, deleted, or edited without altering the original and separate media content 24. The system enables the tagging of objects within content and allows these objects to be matched to any category of interest, and allows sharing of such tags. The system enables ‘search & discovery’ by sorting and matching tags and works with still image media, audio, or video. As if further discussed below, the system architecture, called SMTO for Skin, Marker, Tag and Object utilizes a hierarchical data structure of Skin-Marker-Tag-Object to provide the comprehensive rendition of organized information.

The social networking and sharing platform provides experience-specific opportunities for individuals, corporations and groups to add to and share media content in a manner that provides:

An enhanced viewing and participation experience;

Unique brand development opportunities;

Unprecedented medium through which to provided at-the-moment purchase incentives;

Gateway for monetizing libraries of content; and

Effective interweaving entertainment content with branded and merchandising content.

Additive content is facilitated by a GUI, for example a browser-style interface 28, associated with the display device 40, and depending on the implementation, with the server 44. The GUI 28 and additive content 26 is collectively referred to as a Skin 30. The Skin can be a separate application and/or display area that overlays the media content 24. An illustrative embodiment of the system includes a Reader that can be a stand alone web service application that overlays video or other media content with a Skin, or can take other forms, for example, a browser plug-in that displays the media content with a Skin, for example, as illustrated in FIG. 1B. The information required to generate the Skin 30 may be stored by the system server 44, for example with a unique ID and/or at a unique IP address, while the media content may be sourced from a third party website, for example from media server 46, or alternatively, from the system server 44. Additionally, the system server 44 may include a plurality of keys that each associate a Skin 30 with the media content source feed. New content can be appended to the Skin which overlays the media content by using Writer functionality, for example, embedded into the Reader. Together, the Skin, Reader and Writer provide an “enhanced video” experience.

The system 20 connects conventional dynamic media content with the Internet and associates and displays a variety of types of content associated with a specific selected scene and associated ‘images’ on the media content. The system 20 enables a user to experience rich media beyond the two dimensional playback screen. The system 20 provides infinitely deep layers of meta-information that can be added, deleted, or edited without altering the original content. The system 20 enables the tagging of objects within content, for example, as illustrated in FIG. 2, and allows these objects to be matched to any category of interest, and allows sharing of such tags.

The system enables ‘search & discovery’ by sorting and matching all elements of information in the metadata (skin), markers, tags, and objects within every possible scene within any playback video. The search can be hierarchical, for example:

SKIN title—SKIN description
MARKER title—MARKER description
   METATAG title—METATAG description
      OBJECT title—OBJECT description
         The system integrates viewers around metatags, including premium branded content. The system works with still image media, audio, or video.

Metatag refers to various kinds of content, including media content, that are produced by end-users, including commercial/branding users. Metatags are used for a wide range of applications including problem processing, news, gossip and research. All digital media technologies are included, such as question-answer databases, digital video, blogging, podcasting, mobile phone photography and wikis. In addition to these technologies, user generated content may also employ a combination of open source, free software, and flexible licensing or related agreements to further reduce the barriers to collaboration, skill-building and discovery. The advent of user generated content marks a shift among some media organizations from creating on-line content to creating the facilities and framework for ordinary people to publish their own content in prominent places.

A Skin 30 is a display (GUI) and informational (metatags) layer that is created on or around a video, an audio, or a still content (media content) 24 but is not tied physically to the media content file, for example, as illustrated in FIG. 2. In other words, a Skin 30 created for a movie or news footage can be associated with the content or unassociated from it without changing the physical and intellectual form of the content. A Skin 30 by itself is a placeholder for different types of metadata that maps to the source content at different time based or frame based markers, as illustrated in FIG. 2. Skin content provides users with the full freedom to create, alter, and share every part of a meta information layer that in no way changes the content delivery impression or the way the content may show up on the display 52 without the presence of such meta-layer. For example, one place where the user could experience any additive material on the screen is when the author of the Skin 30 adds subtitles to the content.

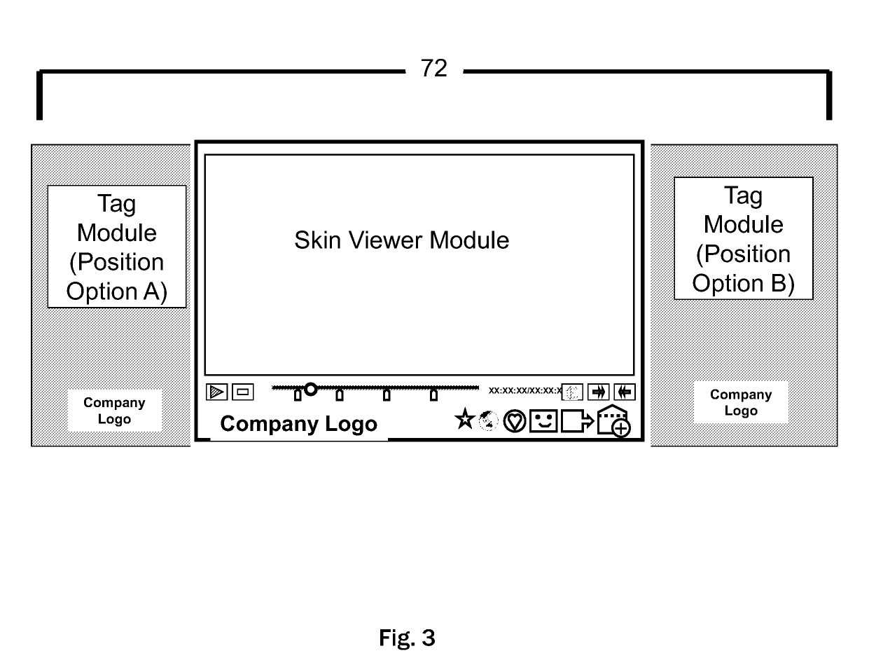

The system 20 is portable and settings can be saved in a personal account, shared with other system members, and forwarded as an email attachment to any Internet user. However, the Internet user will require a Player Interface 70 (FIG. 3) to play the Skin 30. The Skin 30 is sourced from the system server 44 and database 42, and the associated media content 24 may be sourced from a media server 46 or the system server 44.

Player Interface

The system includes a Player Interface 70, or “Reader”, that is a software application that can play a Skin 30 along with its associated media content 24 in an audio/video playback or a still content viewer (i.e., image) interface. As shown in FIG. 3, the Reader 70 can generally include a skin viewer module, a metatag display module (MDM or Experience Console) 72, and an advertising/analytics module 74. The Reader 70 displays the associated media content 26 and parses every available inserted marker (for example, added by the author) and renders all meta-information attached to the marker in the GUI. In one illustrative embodiment, any metatag information created by a user and displayed by the MDM is rendered to the left or right of the video playback display area. The Reader 70 can also display advertising, either in the metatag display area 72 or a separate advertising area 74, and collects analytics associated with the media content, markers, and meta-information.

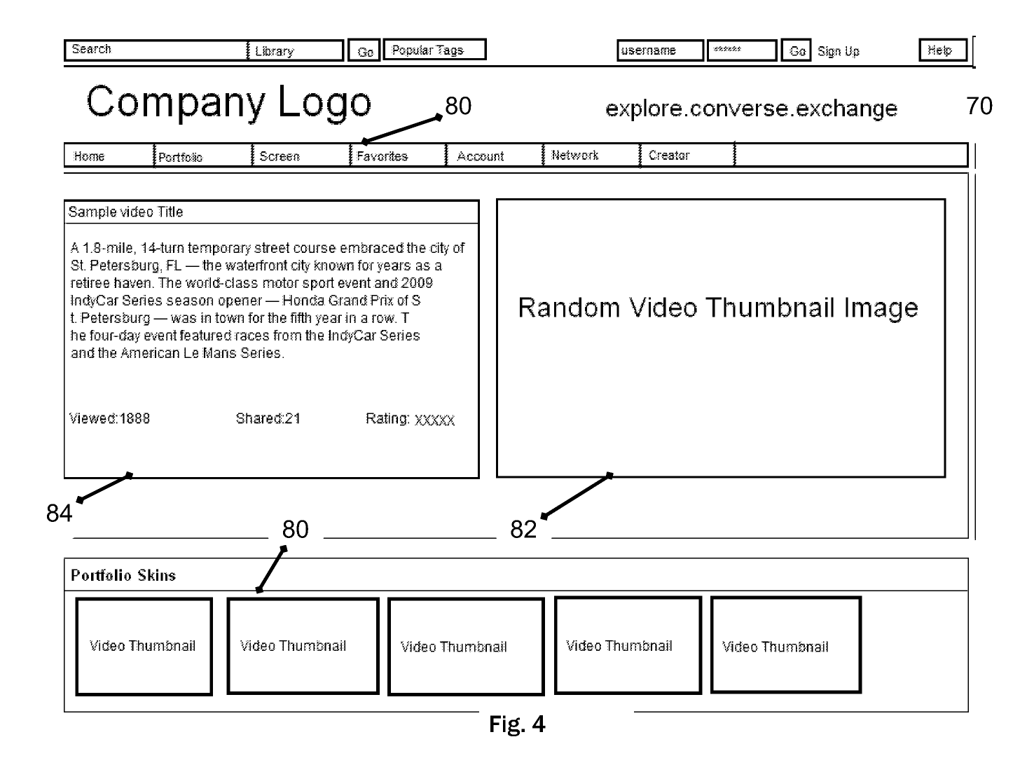

The system Reader 70 can be a standalone application, or can sit on any compatible content player and has the ability to locate a marker and render any information associated with the marker that is constructed, for example, in the form of a metatag. Referring to FIG. 4, an illustrative embodiment of a Reader 70 associated with the system 20 includes a Portfolio view 80 displaying a set of available Skins 30 that are associated with the user. The Portfolio view 80 also provides a preview 82 of media content 24 and a metadata display area 84 providing information relating to the previewed Skin 30 and associated media content 24.

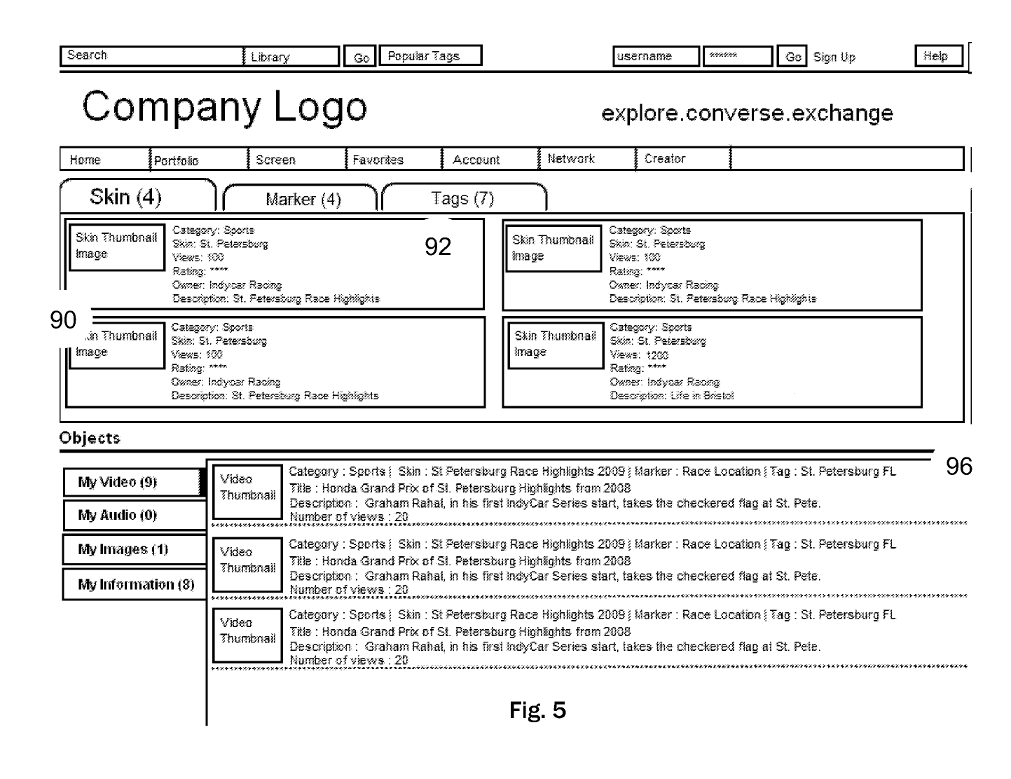

Referring to FIGS. 5A-5C, the Reader 70 also includes a Favorites tab providing a preview and information for Skins 90 (FIG. 5A), Markers 92 (FIG. 5B), and Tags 94 (FIG. 5C), each view of which includes a listing of various types of Objects 96 associated with the Tags 94. For example, an Object 96, which is added content associated with the media content 24, can include video, audio, images, hyperlinks, or other information.

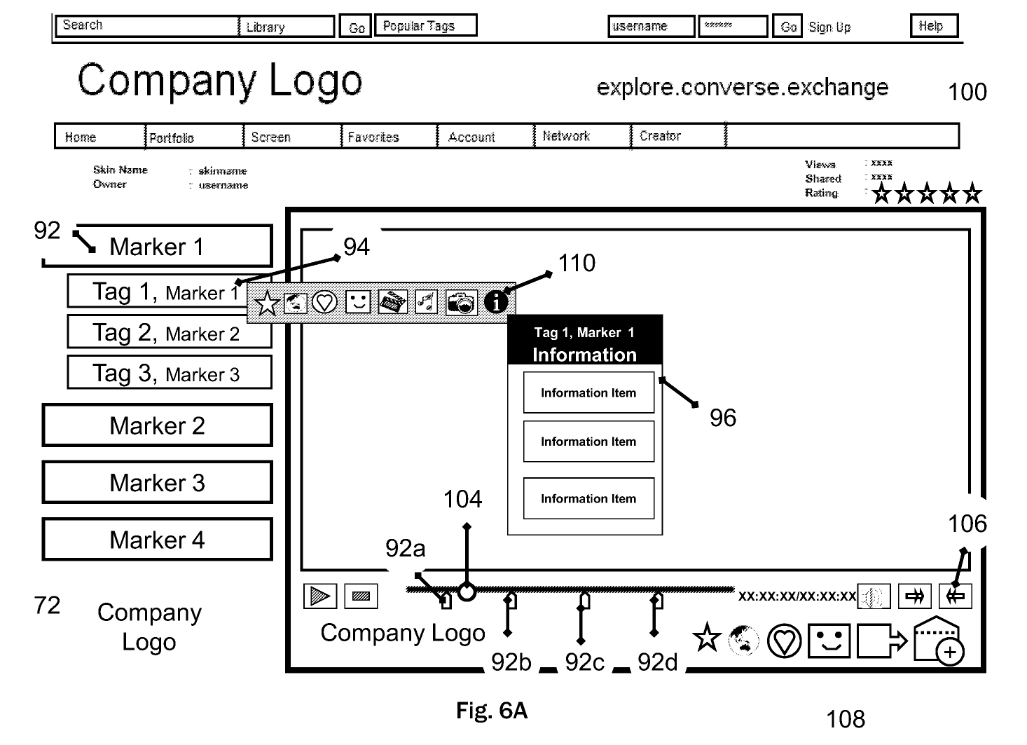

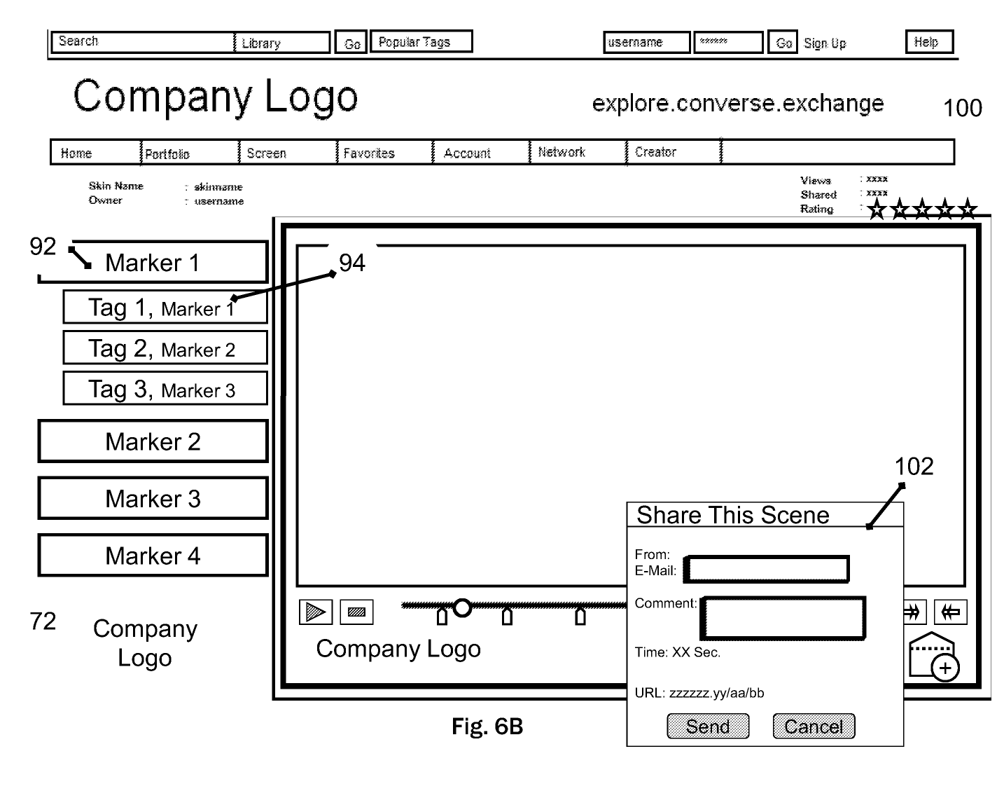

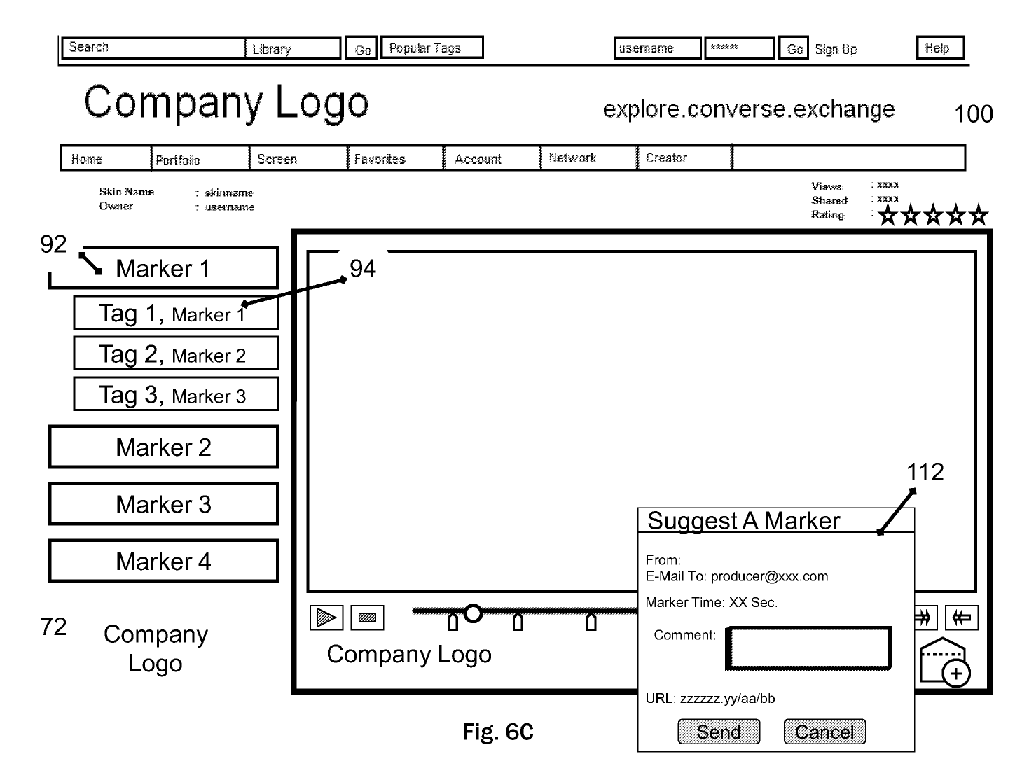

Referring FIGS. 6A-6C, an illustrative embodiment of the Screen view 100 of the Reader 70 is shown displaying a Skin 30 associated with media content 24 about racing. In FIG. 6A, an Objects 96 associated with a Metatag 94 at Marker 92a has been selected and is being viewed. In FIG. 6B, the user has selected the share tool 112 to share a scene of the media content with another user. In FIG. 6C the user has selected the suggestion tool 104 to suggest a marker to the owner of the Skin 30.

A metatag is the lowest denominator in the hierarchy of meta-information and can store several types of metadata Objects such as URL links, free form text, images, short-form video/audio or still content clips. The Reader 70 renders the metatag information and the parent marker title in the MDM 72 associated with the reader and that sits next to or frames the media content display screen 100. The MDM displays markers 92a-92d and corresponding metatags 94, for example, in vertically placed rows with the marker last parsed (history marker) at the top of the MDM, most immediately available marker (current marker) showing up next in the marker-tag display stack, and followed by the next available marker (future marker) below it, for example, as shown in FIG. 4. For example, the marker and corresponding tags can be shown in a parent-child relationship structure, where all metatags related to a marker are displayed under a marker title.

Media Content Control Augmentation—Play Mode: When user plays media content 24 with the Skin mode ON, the Reader 70 parses markers in a forward viewing direction. For example, a minimum of three markers 92 are displayed in the MDM 72. And the Reader reads two markers at any current instant. At the beginning of the play, the Reader reads and renders two markers from the starting point of the media content. As the frames are rendered in the media content display, and the current frame is posted, the Reader 70 highlights the marker associated with the frame or time, while any following available marker is also displayed in the MDM, all showing up in the display panel. For example, the current marker stays highlighted for a very nominal time before the next frame or time associated with the following marker is reached, for example, the time is calculated by measuring distance of the playback scene cursor from the two markers before and ahead of it. Once the frame/time proximity is reached, the highlighter enables on the marker associated with it and subsequently renders another marker and its content available next. Although using this Look Ahead rendering reading method, all history marker-tag hierarchy rendered earlier will stay in the MDM container and can be hidden or exposed by user choice.

Additionally, as shown just below the media content 24 in FIG. 6A, a sliding time bar with an indicator 104 of the present frame time relative to the entire media content segment is displayed. Also associated with the indicator are graphic representations for Markers 94a-94d based on the particular time segment with which each marker is associated.

While the user views the media content with the Skin mode ON, the user can use typical the regular functionality controls 106 of a media content player, for example, pause, stop, fast forward, and rewind. Any action on these controls 106 will also affect the rendering of the markers 94 and their metatags 96 on the MDM 72. For example, if the user clicks on pause or stop, the Skin Reader 70 will also pause or stop rendering any marker 92 and its associated content beyond the most recent marker posted in MDM. However, all previous markers 92 and their content can stay visible on the MDM 72 with all their links and hotspots active. Thus, for example, when the user rewinds the media content 24, the highlighter moves off of the most recently parsed marker or the current marker (current frame/time) and highlights the marker that is nearest (frame count or time count) to the frame/time where the user has rewound to.

If the user fast forwards a media content, then all markers 92 and their metatag content available up to the point where the user seeks to watch will be parsed and can be rendered in the MDM 72. The closest marker 92 (in a direction negative to media content progression) or any marker attached to the frame/time where the user has landed after fast forwarding, will be highlighted in the MDM. 92 ‘Look Ahead’ enables the display of one more marker following the marker associated with the current frame/time or the closest marker mentioned above.

For a Skin, one or more of the following features 108 are available to the user: rate, share skin, favorite, emoticon, share scene, and suggest marker.

For a marker, one or more of the following features are available to the user: rate, share, favorite, emoticon, and the following:

(a) Ability to save the marker in a personalized ‘Favorites’ area. This action also saves all the metatags associated with the marker. When a user saves an entire marker, the Reader captures a small amount of media content associated with the marker (enabled by the Author) and saves it along with the marker in a database supporting the Favorites.

(b) Ability to view the frame/time attached to any marker available in the MDM. This action will rewind or fast forward the media content to the frame/time associated with the marker. In case the user seeks the most recently available marker in the MDM whose frame/time has not yet been rendered in the media content display screen, the media content player will fast forward to the associated frame and any marker following the one sought by the user will also be rendered (but not highlighted) in the MDM. This follows the basic Look Ahead rendering method as described above.

(c) Ability to shrink or expand a marker to hide or view all its metatag information. This saves space on the MDM and gives the user the freedom to view the meta-content in a more personalized manner.

For a metatag 94 the user can select a particular tag associated with a marker 92 to display meta-information 96 associated with that tag, as shown in FIG. 6A, including selectively interacting via tag interactions 110 with particular Objects 96 associated with the metatag, including video, audio, image, or other information or Objects associated with the metatag, or particular available features associated with the metatag. For example, selection of a metatag may transmit the following information to the system server: Skin ID, Marker ID, Metatag ID, User IP Address, User Account Information, and Time of Play Requested. Additionally, for a metatag one or more of the following features are available to the user, for example, as selectable from tag interactions 110 shown in FIG. 6A:

(a) Ability to save the metatag in a personalized ‘Favorites’ area. This action also saves all the objects associated with the tag, for example, images, comments, ratings, media content clips, etc. When a user saves a tag or associated objects, the system Reader can also capture a small amount of media content associated with the marker (enabled by the system Author) that the tag belongs to and saves it in a database hosting the user-favorites.

(b) Ability to forward or share the metatag with any others, for example system account holders.

(c) Ability to save or forward any objects associated with a metatag.

(d) Ability to move to a scene or frame/time in the media content display area associated with a metatag.

(e) Ability to add comments, texts, URL links, and other rich media objects to a metatag

(for example, if wiki enabled by the creator of the source Skin during authoring).

(f) Ability to rate a metatag.

(g) Ability to import a metatag to a different Skin marker, for example, associated with a different content.

(h) Ability to view analytics gathered around the metatag information by storing all actions made with the metatag. Analytics will provide a complete tiered analysis of number of hits on a tag, number of times a tag is forwarded, ratings of a tag, categories under which this tag has been imported, number of hits or clicks on the tag under a category, and similar statistical attributes.

User will have the ability to pause any scene in a video and forward it to another person via email, instant posting technologies or other social networking tools such as delicious, stumble upon, twitter, facebook, etc. right from the playback console. This message will derive from the system a unique URL of the frame of the video that the user selected and will compose a message dynamically. Other third party entities can also wrap that message with brand messages, which include but not limited to marketing tags, banners, awareness annotations and other merchandise related postings.

User also can pause a scene in a video and send it directly to the owner or other assigned ‘Point Of Contact (POC)’ of the content with messages related to that particular video scene or frame of context. The message will send the video scene or frame in the form of a URL to the POC. Once the POC receives the message, he/she can take actions on the suggestion/question and communicate directly with the submitter of the message.

A user can subscribe to any marker or tag if the option of subscription to a RSS type feed is enabled by the owner of the marker or tag. By subscribing to the marker/tag, the user can remain aware of any new announcements made by the owner of the marker/tag. All communication related to the marker/tag will be delivered to a message inbox tied to the user account in the enabled system.

The system 20 can connect a ‘hotspot’, for example a subset of the display frame or an object in the video, enabled on video with any marker 92 or tag 94 that is linked with the context where the hotspot is created. For example, from the GUI side, when a user sees an object of interest on the screen 100 and rolls a mouse pointer over it, or clicks on a hotspot in the video, there could be multiple responses, such as:
1. A marker 92 will flash up to denote that the hotspot has more information in the marker;
2. A tag 94 will flash up to denote that the hotspot has more information in the tag; and
3. Any dynamic UI rendition in the form of popups, new windows, color changes and any visual identifiers of actions can be implemented to the hotspot driven mobilization of a marker or a tag.

The system Reader console 70 allows a viewer to rate the entire Skin 30 and send any personalized message to the creator of the Skin. The Reader 70 can also include a section where the creator can post links to any blog or forum associated with the content.

The system 20 gives the ability to dynamically feed advertisements/promotions/vendor messages at different marker positions 92a-92d (timecode or frame) of one or more skins 30 on the fly, for example, in the advertising area at the right end of the Skin 30 shown in FIG. 3.

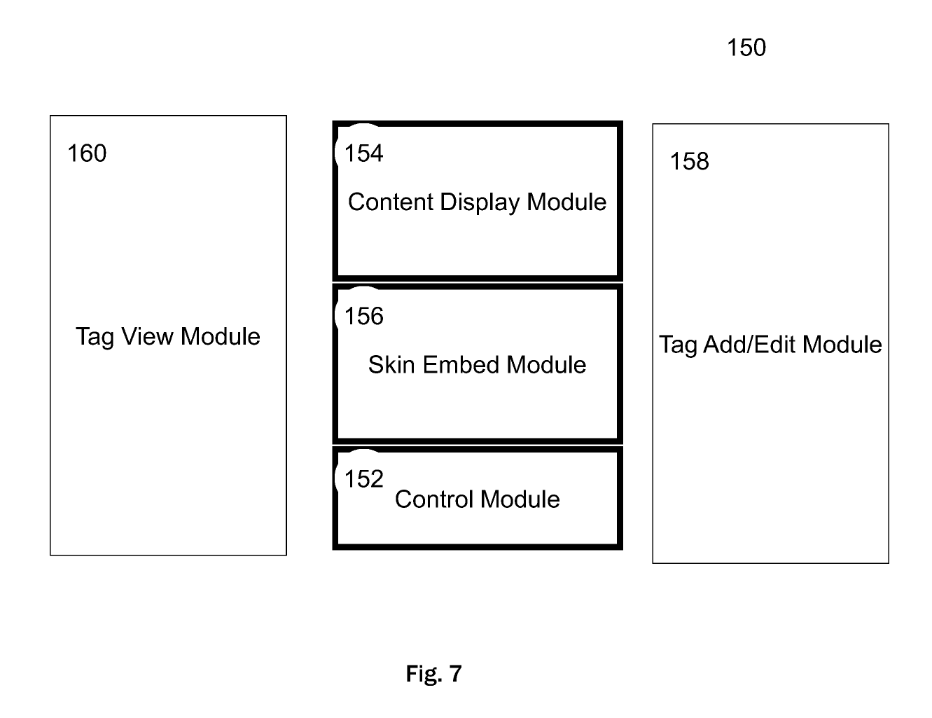

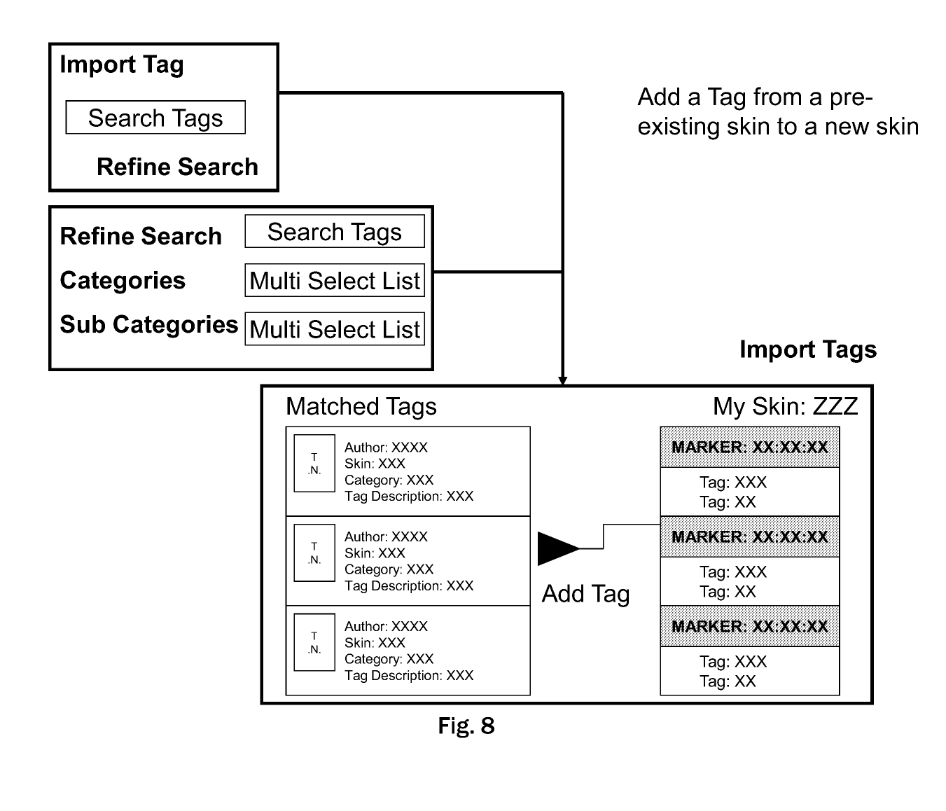

FIGS. 7A-7C show an illustrative embodiment of a reader 70 of the system 20, and in particular the user Account Info. FIG. 8 shows an illustrative embodiment of the Social Network of the reader 70.

Author Interface

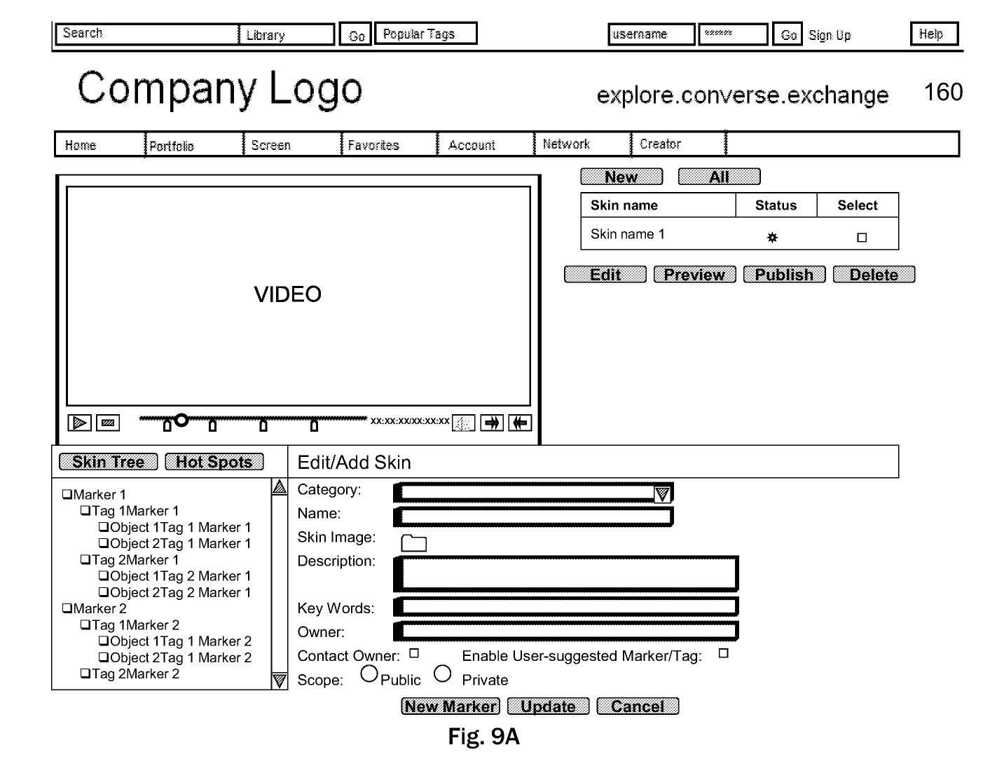

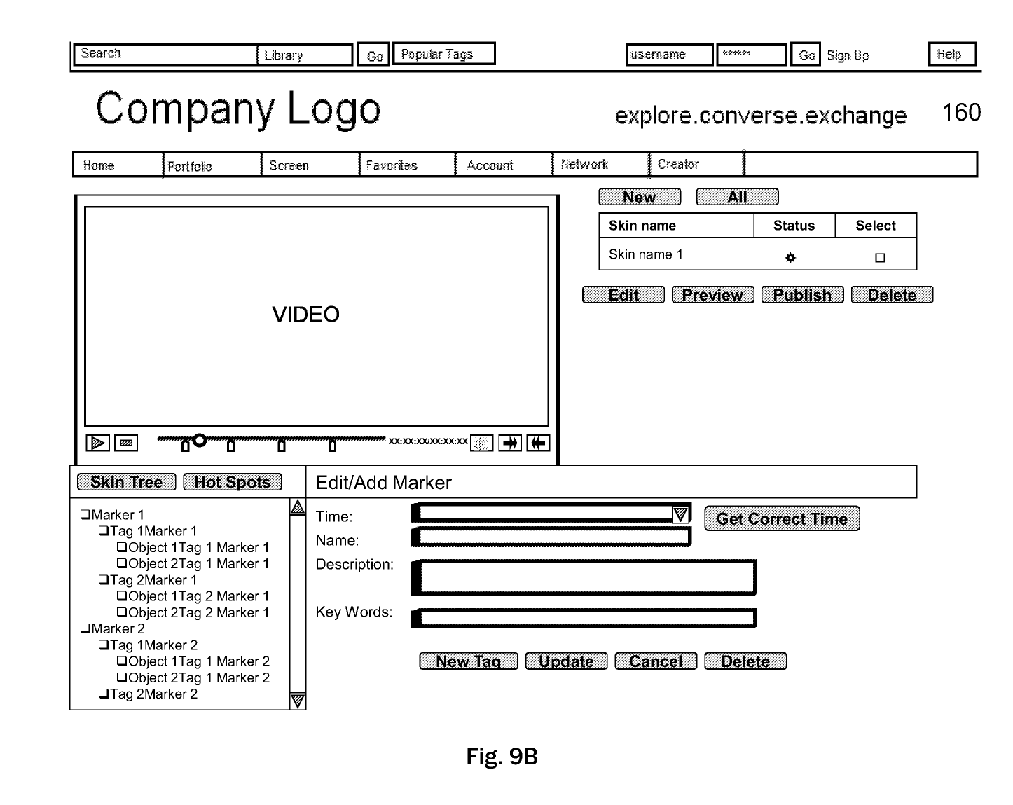

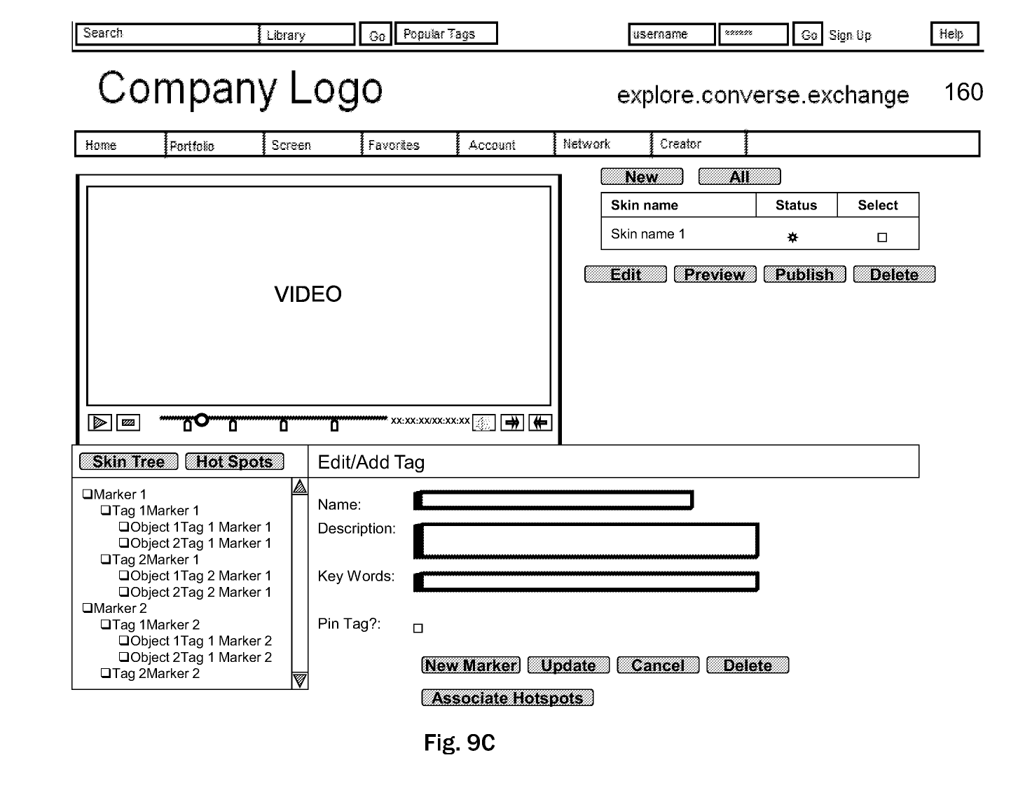

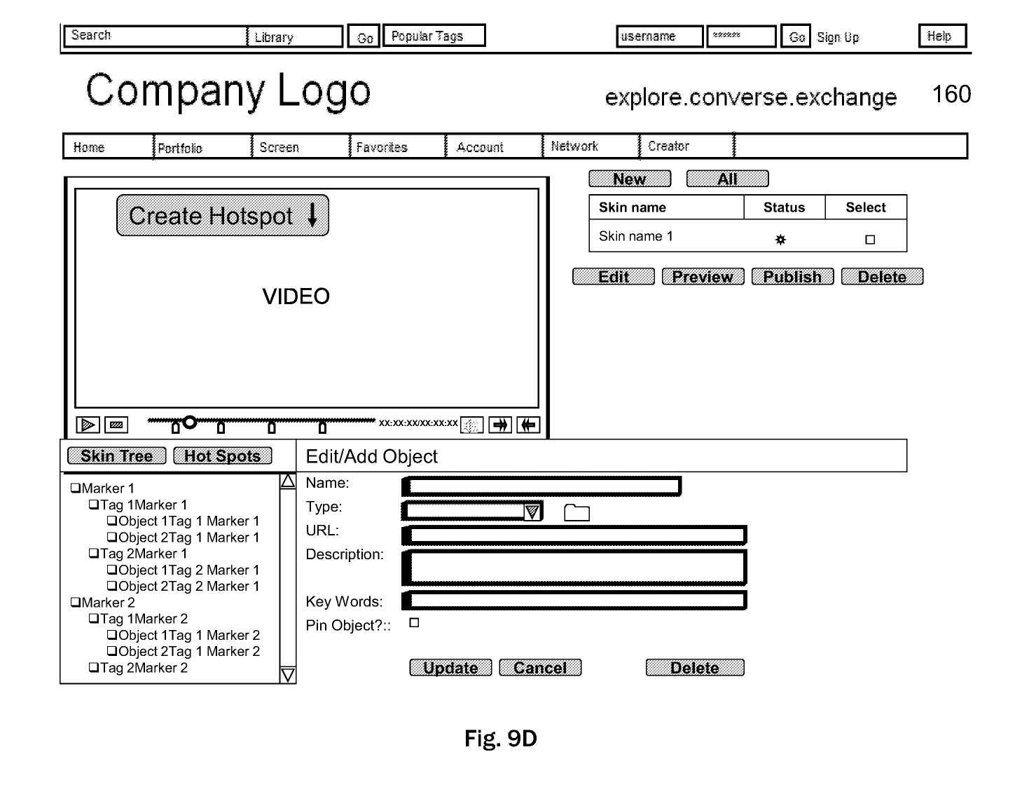

The system Author interface 150 enables the user to create a Skin over a media content that the content creator/producer has given permission to do. The system 20 can include a built-in features that prevent any third party entity from writing Skins 30 and other associated metadata with a content 24 unless the content provider or creator has given requisite levels of Skin generation permissions on the full content or parts of it to the third party or to all users. As shown in FIG. 9, the Author interface 150 can generally include a control module 152, a content display module 154, a skin embed module 156, a tag add/edit module 158, and a tag view module 160.

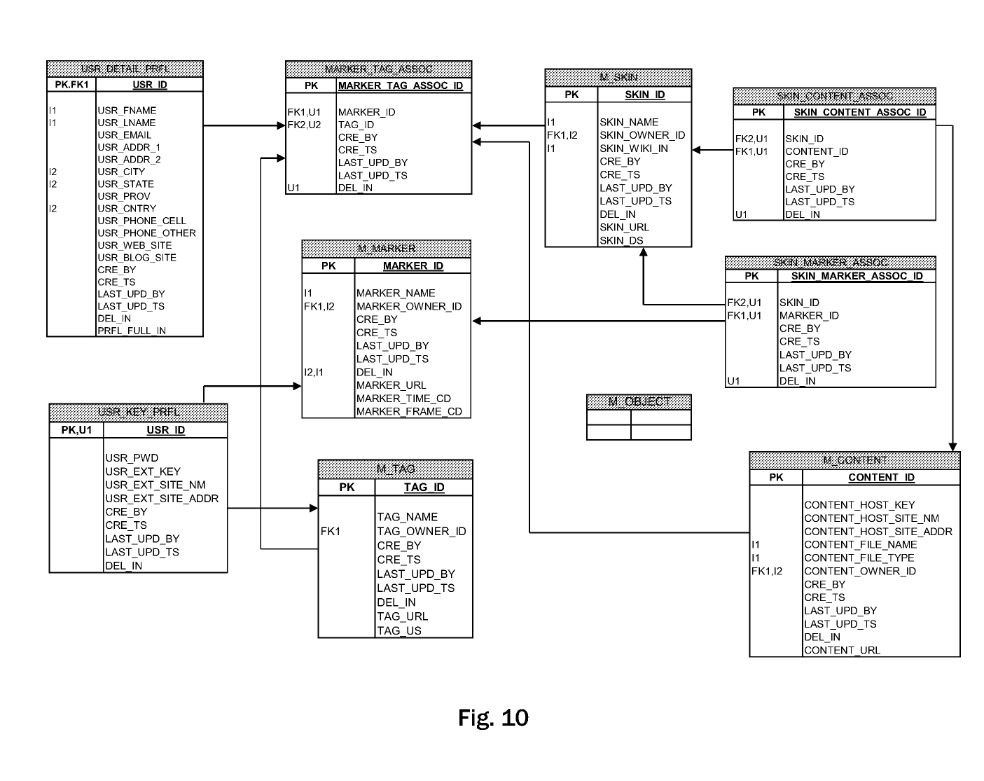

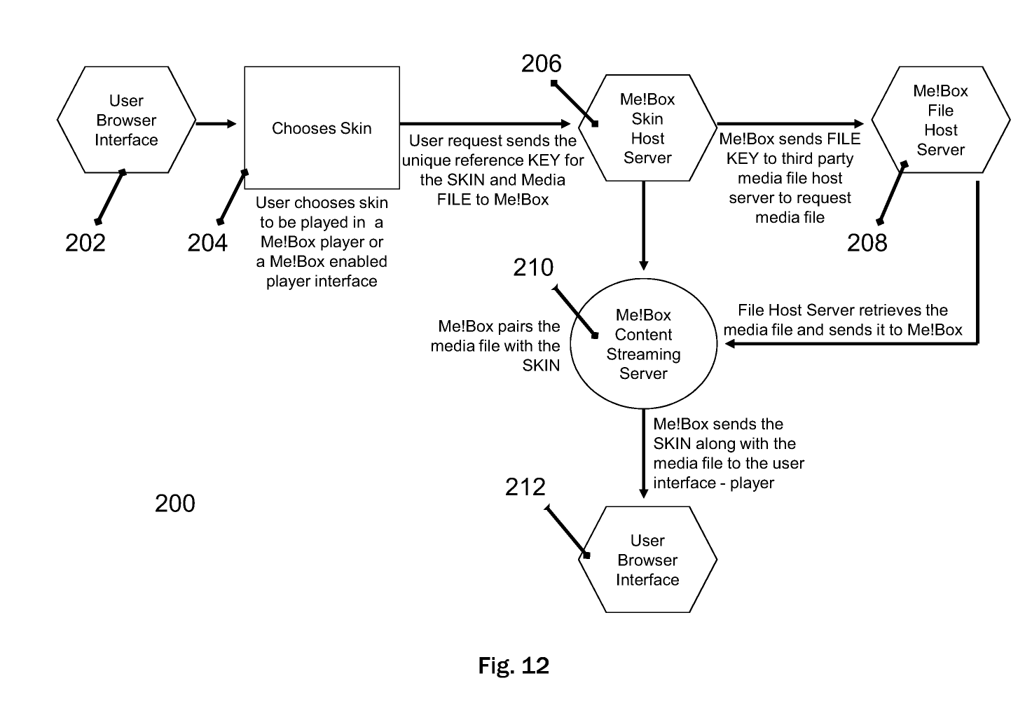

The Author interface 150 can be used to create a new Skin 30 associated with a particular media content 24. Only one content 24 can serve for one Skin 30 whereas many Skins 30 can be created for a particular content 24. Referring to FIG. 10, an illustrative display layout for the Skin Author interface 150 includes display areas associated with the various modules 152-160, and allows the user to load media content 24 that the user would like to generate a Skin 30 for. Once the content is loaded in the interface 160, as shown in FIG. 12A, the user can assign a Skin name for the content. Additionally, every Skin can be assigned a WIKI ON/WIKI OFF status that opens/closes the possibility for third parties/viewers to add personal inputs (texts or objects) to the metatags embedded within the markers of a Skin.

If a Skin 30 is given a WIKI ON (ability to add/edit to an existing attribute) status, metatags are set to WIKI ON status by default. However, a user can individually choose a marker to be WIKI OFF, which in turn prevents anyone (other than the creator) from adding any comments, texts, or objects in any metatag under the specific marker.

After generating a new Skin file for the media content, the user can use the Author interface to move backward or forward to any scene or audio segment and select that scene/segment for marker generation, as shown in FIG. 12B. Once the user identifies a particular scene, he/she has to save the scene/segment reference to a placeholder to make it available for marker additions. A marker added will now refer to the particular scene/segment and will be unique to the scene reference pointer, which could be a frame, a timecode, or any other attribute of the media content content.

Once a marker is generated for a scene/segment, innumerable metatags can be created for a marker, as shown in FIG. 12C. These tags can include objects, as shown in FIG. 12D, including the following types: texts, URL links, images, audio/video or still content clips, and files. For a tag element with size beyond a certain limit up to which rendition of the element is conducive to a fast user experience, a link to the physical element from the tag is included. By clicking on the link, the user can view the element (for example, large file, audio clips, audio/video or still content clips, etc.) in a separate console.

Every metatag associated with a marker can include a title, a brief description, number of views, number of references, number of forwarding, and number of appearances/occurrences of the tag in other Skins across the world.

After a metatag is created under a marker attached to a scene/segment, the user can allow (or disallow) WIKI ON to the marker so that all metatags within the marker are also set to WIKI ON (for example, allowing viewers to add comments, links, pictures, and/or rich media to the tag).

A metatag is created under a category-sub category structure that facilitates identification of the relevance of the meta-information associated with the tag. The system can generate a sophisticated category-sub category tree, for example, based on user feedback, industry benchmarks, and user interests. Every metatag includes category-sub category information attached to it.

While building a metatag, the user can attach different elements to a tag by dragging and dropping URL links and files through a tag element explorer and loader. The system Author will also provide the interface to extract any publicly available rich media content across the Internet to be embedded into the metatag.

All information stored in the Skin components are saved in the system database and are keyed in with a owner indicator. The owner indicator allows any viewer to know about the content owner and the Skin owner details if visibility is allowed by the content or Skin owner.

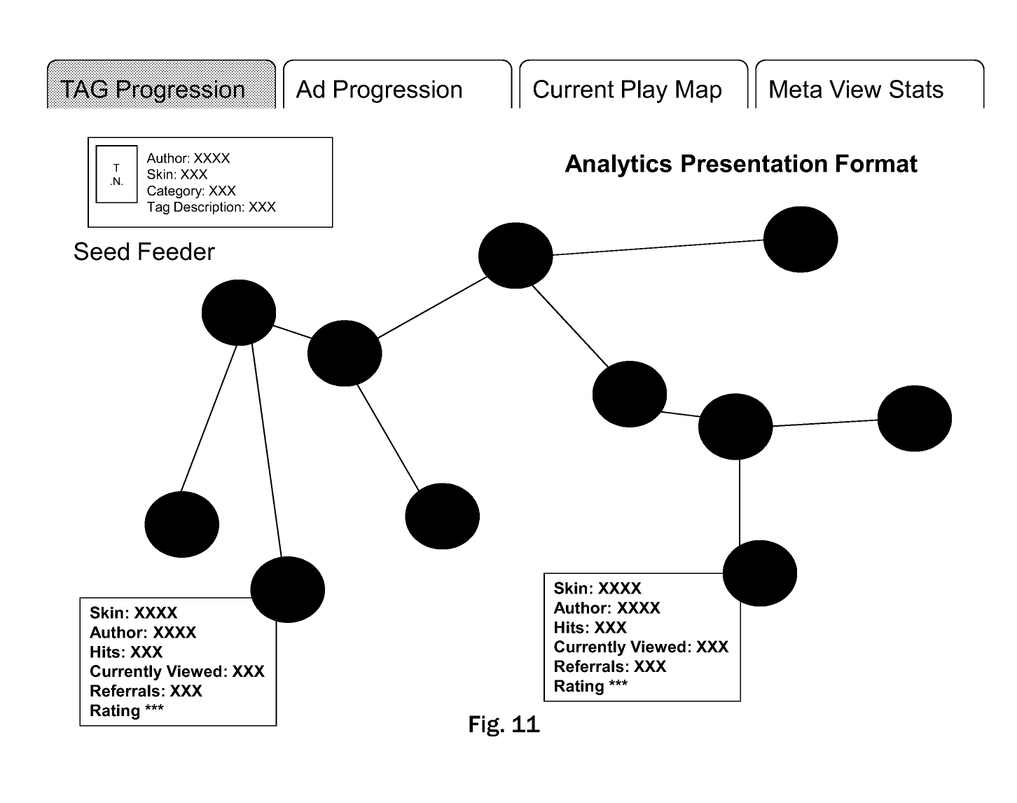

A marker can not be imported or shared across Skins since a marker is unique to a scene/segment of the content. However, metatags within a marker can be shared, forwarded, and imported across different Skins, for example, by searching for and selecting a tag as shown in FIG. 11.

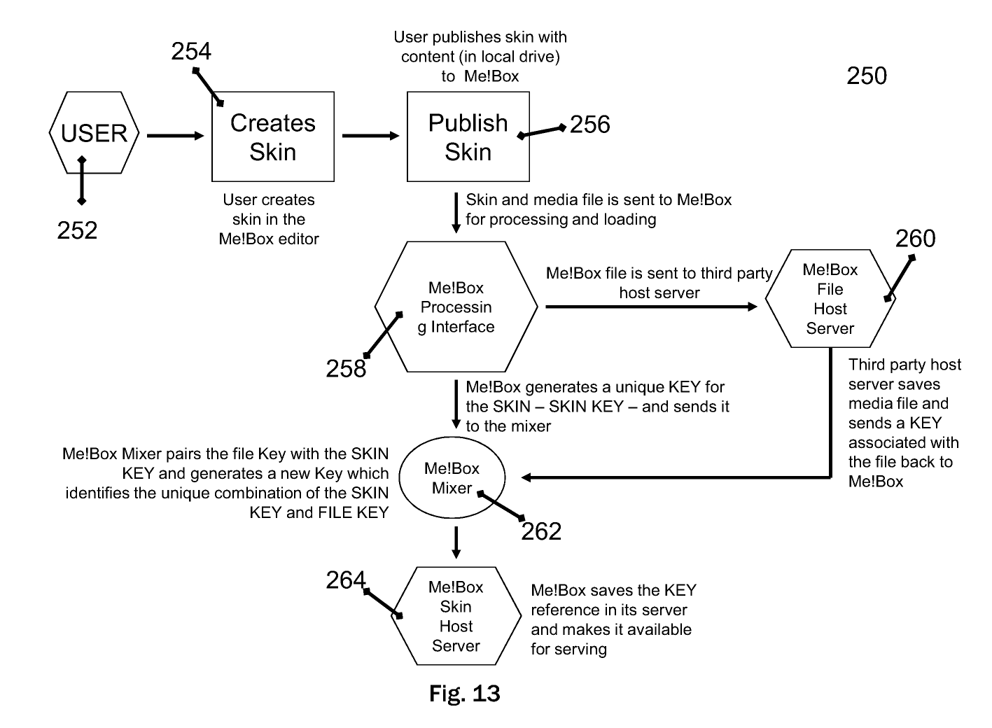

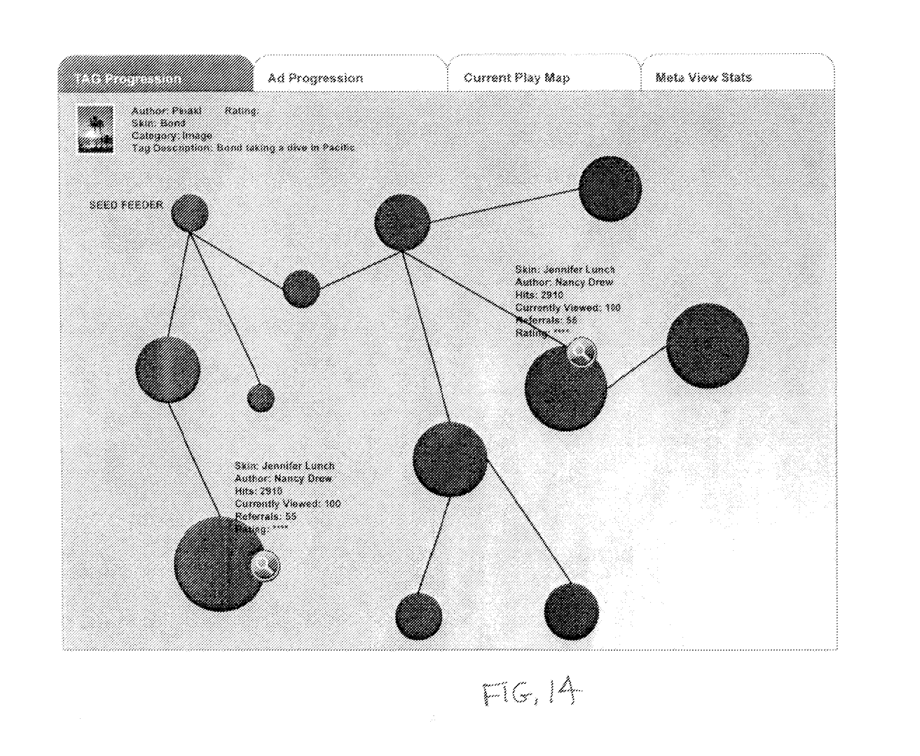

All markers and their associated metatags in a Skin constitute the meta-information that is not embedded in the media content. When a user creates skin, marker, associated metatags, and associate objects, the data and association hierarchy is saved in the server database 42, for example, using the illustrative data structure shown in FIG. 13. While creating the marker-tag portfolio for a Skin, the user is able to observe the hierarchy formation through a dynamic display module as they are formed. This allows the user to view the marker-tag tree associated with the user's Skin for reference. Each metatag will have a tiered hierarchical category structure with an “Ultimate Parent-Parent-Child relationship”. The server database will have a table that maintains this relationship as defined by the design team. An example of category structure is given below:
[Ult Parent-Parent-Child]: Movies-Action-War OR Sports-Outdoor-Baseball

However, multiple such tiers will be defined according to the variety of content and users as aggregation and tagging of content progresses. An illustrative embodiment of a metatag structure is:

```
Tier-A
[Ult Parent1-Parent1-Child1] > A1 index
[Ult Parent2-Parent2-Child2]
[Ult Parent3-Parent3-Child3]
        Tier-B
        [Ult Parent{A1}1-Parent{A1}1-Child{A1}1] > A1B1 index
        [Ult Parent{A3}1-Parent{A3}1-Child{A3}1]
        [Ult Parent{A3}2-Parent{A3}2-Child{A3}2]
                Tier-C
                        ... Tier-N
```

All child tiers will be connected to their parent tiers by a unique data pointer. Every tier will carry its own set of [Ult Parent-Parent-Child] categories. The following tier will be an extension of the above tier in terms of sub-sub categories and sub-sub-sub categories and beyond. This structure enables an unlimited number of tiers and upon the removal of any sub-sub category relationship, the content will still be categorized under the sub-category hierarchy without any change in core classification.

The relationship can be flattened to identify a particular content, for example:

| Content | Category Hierarchy |
|---|---|
| Saving a Private | Movies-Action-War-WWII-Europe-France- |
| | Invasion-90:120MinLong-PG13 |

This above formulation gives the user the ultimate search criteria to identify and locate content as close to their interest as possible.

Categories are assigned when a user uploads their skin/content to the server. User are able to choose from a set of such hierarchical structure to assign their content. If a sub-sub category is not available at that time but becomes available in the future, the user will be notified about the availability and given a choice to assign the newly available granular hierarchy to its existing category structure.

Category structures are developed and provided based on search pattern, comments made, and information appended to metatags associated with a skin/content, thereby providing state of the art search and discovery that is not available with existing media delivery platforms.

The system server database holds all Skin, marker, and metatag information associated with a specific media content. A content key is associated to a Skin key, which in turn is associated with all meta-information of the Skin to the content. The system includes a search engine that will allow searching of media content across the world that has been associated with one or more Skins Users are able to locate a media content or a Skin through keyword searches. Keywords searches can include Skin titles, marker titles, tag titles, tag descriptions, tag comments (for relevance), and tag elements and their attributes. An illustrative set of tables and fields associated with the system and contained in the database is shown in FIG. 13.

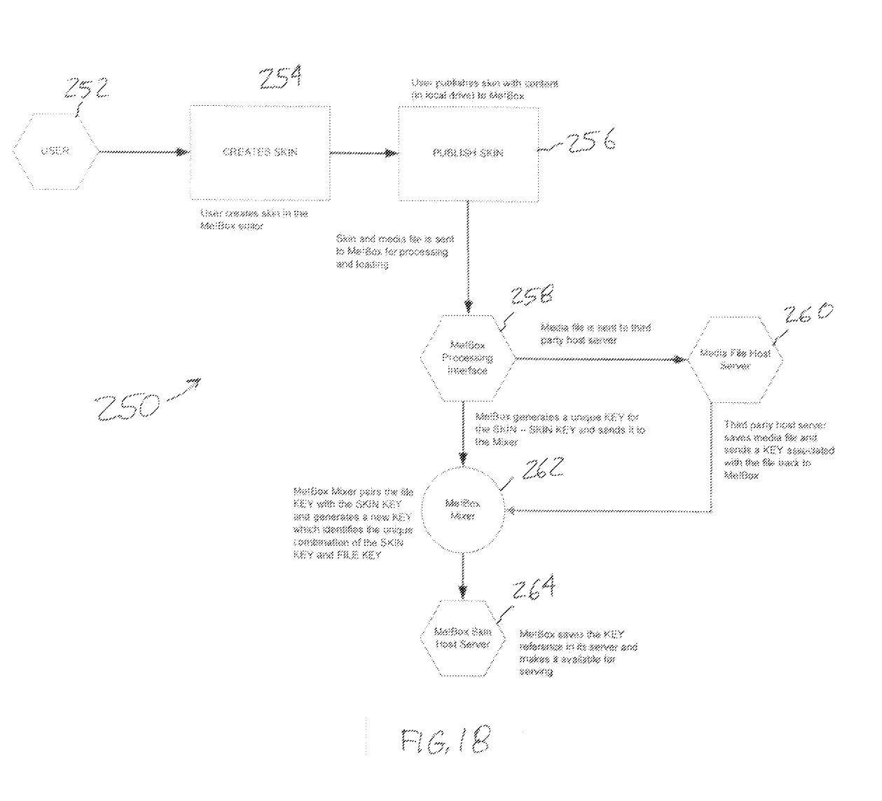

FIG. 17 shows an illustrative algorithm 200 for viewing a Skin using the system 20, the steps 202-212 as described in FIG. 17.

FIG. 18 shows an illustrative algorithm 250 for authoring a Skin using the system, the steps 252-264 as described in FIG. 18.

All metatags, markers, and Skins are exposed to ratings. Any viewer, with or without the ability to add/change information on a Skin, will be able to rate the Skin, its markers, and any associated metatags. The rating value of every attribute will be updated across all their occurrences in the system world.

Commercial use of the system can include, for example, an online movie trailer, the system enabling meta-information relating to the movie, including, a contest, featured product information and merchandising, videography on artists, links for movie times and tickets, metatag feedback on the movie, links to other movies including the same actors, directors, and other artists, content on each artist, soundtrack information, content on soundtrack artists, content on movie venue, virtual tours of key locations in venues, specific venue information and metatag, reservation and product consumption information, and RSS widget.

With user generated media content, the meta-information associated with the content includes the social networking page of the author; soundtracks; link to locations where video was filmed, for example, a ski resort; metatag of associated content; metatag on best attributes at locations, for example best ski runs, and including destinations such as best place to stay, best bars, best shops, etc; links to sponsors or favorite products; how to videos specific snowboarding moves; links to Winter Olympics highlights, X-Games highlights, etc.; interviews with snowboarding stars; blogs and third party content on snowboarding; incorporated content on snowboarding contest; incorporated coupon for 20% off lift ticket; and RSS Widget.

Anyone who wishes to engage media in a multi-directional information flow is a likely candidate for using the system, including, for example, movie creators and distributors for creating media-based communities, advertising, long-tail media life, historical documentation, on-line commerce; industry for promotional applications, training, R&D, brand-based community development, product-based community development, historical documentation, on-line commerce; education for information sharing, courseware, on-line education, recruiting, promotion, research, historical documentation, on-line commerce; media/advertising agencies for brand-based community development, point-of-engagement promotions, product sales, product marketing, community-based market development, target marketing, information gathering, on-line commerce; military, for training, information gathering, recruiting; sports for training, promotion, community development, advertising, target marketing, audience engagement at live events, on-line commerce; music promotion for community development, community-based marketing, target marketing, promotion, advertising, audience engagement at live events, on-line commerce; government, for R&D, information gathering, historical documentation, training, community development, on-line commerce; gamers, for integrate FPS and scenario content on top of online game play/MMOLG, integrate cheats, forums and other online player resources; and individual users, for community participation, community development, entertainment, research, on-line commerce.

Types of media content with which Skins can be associated include, but are not limited to, movies; podcasts including live events; video blogs; gaming; musical arts; visual arts; education including learning labs, on-line learning/distance learning, study guides, self-paced learning guides; sales and marketing, including audio-video brochures; industrial applications, including R&D archives, product manuals, training and development, and inventory; home use, including home movies, family movies, and family albums; government and defense applications, including R&D archives, product manuals, training and development, and inventory.

### Use Case Examples

A user adds comments/info/links to a Skin with markers in 5 different sections of a popular movie, for example Top Gun. The user then saves these 5 markers in his favorites bucket attached to his Skin, which can be seen through any system Reader. While watching Top Gun, a second user searches for information on the F-14 Tomcat and the Navy's Fighter Weapons School (“TOPGUN”) program. With one click, the second user activates the first user's Skin which now “overlays” the movie (or scene or clip). The second user is now engaged in the video and metatag content on the F-14 Tomcat. She also checks out the first user's comment on the promotion Honda was associating with Tom Cruise's motorcycle in the movie, streams the video of that motor spotlighted in the TV show ‘SuperBikes!’. She notices a number of markers associated with motorcycles and clicks on the motorcycle configuration gadget which is embedded in the Skin. She also prints out a Honda promotional coupon. Suppose the second user loves one marker on the first user's Skin that has some info that is very beneficial to her. She can save some or all of his markers in her bucket, the two of the six markers placed by Honda, the marker placed by Versus Network which airs SuperBikes!, and one of the markers placed by the US Navy.

Now a third user, while experiencing the second user's Skins and favorites, comes across a snapshot of the marker that the second user had saved earlier. The third user wants to check out the details of the Honda promotion and would like to see the motorcycle in action in the movie. Without loading the full movie and then jumping to that section, the third user can just see a 20 sec roll of actor Tom Cruise on the motorcycle from the scene where that marker was initially attached, plus six other movie and video clips that highlight that specific motorcycle in action, and a sound file of the engine going through it's rev cycle. Thus, the third user can experience every marker individually across all content without the need of loading a media content (attached to different skins) fully into his player.

Scenario 1: The first user is fragmenting content by niche interest. The user is not only pushing targeted content to a limitless number of people, but also now allowing people to save favorite markers and cropping small snippets of the scenes for fast access and hyper targeted re-experience.

Scenario 2: The third user can now do a something else. He can search for all Honda motorcycle related snippets across all skins saved in the system. For example, he now has 150 snippets as thumbnails that are associated with Honda motorcycles or promotions across different movies and other content in which he is interested in. In addition, the user is not required to see the full contents. Using the Reader, he can browse these snippets (5-20 sec rolls) one after the other without loading the full length media content.

Scenario 3: Now what can happen? The third user is not only aware of the motorcycle in all possible contexts identified in the system, but also is actually interested in seeing other movies with great motorcycle sense that he never knew existed. He has access to the motorcycle's specs and can experience a real or a virtual ride compliments of Honda.

End Product 4: The first user now know that the third user has watched the first user's marker snippet (which was saved by the second user) and also has watched ten other marker snippets associated with motorcycles. So the third user is a motorcycle lover with the same passions and interests as the first user. Through the system, the first user can reach out to the third user as a friend with a common interest. The first user can learn through the system Reader that the third user is a member of a particular social networking website, which is where the first user can engage him (thus not adding to the problem of yet another social network, with the issues associated with profile development and portability).

Scenario 5: A commercial user, for example Honda, knows exactly how many users have shown interest for their motorcycles, where that activity occurred, what types of data was appended to the video, by whom, who used what tools, the time it took for activity to translate into engagement (i.e. printing a coupon and showing up at a dealership), etc.

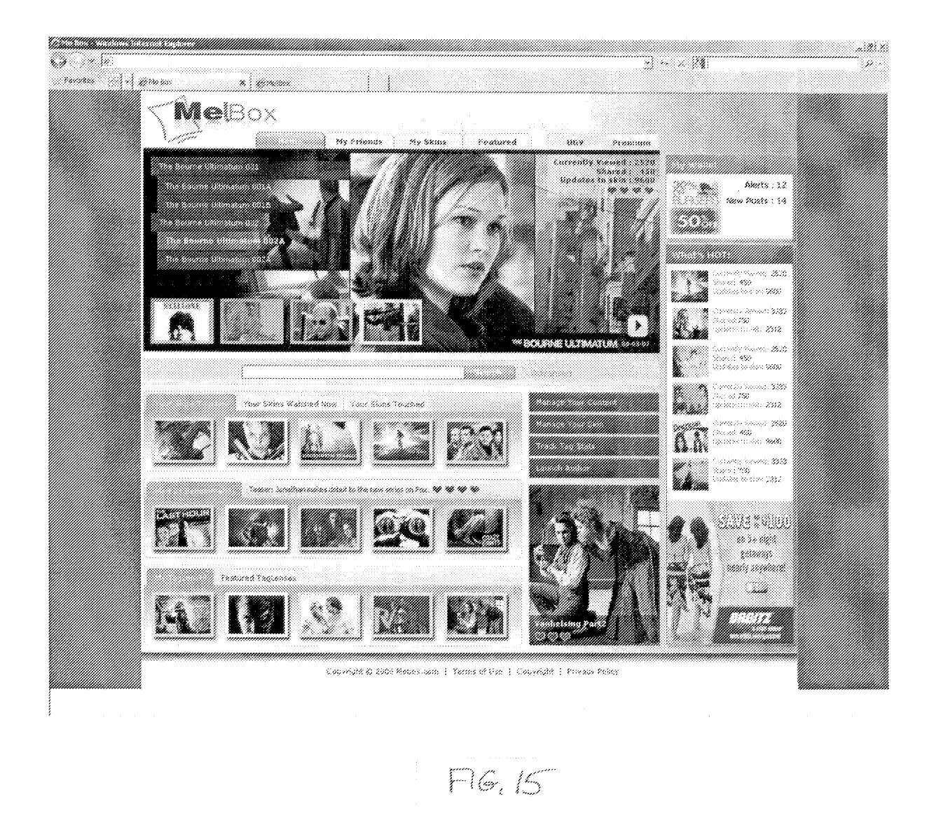

Scenario 6: The distributor of the movie with which the marker was associated, for example Paramount Pictures, knows exactly what scenes around which people are engaging, what the community is active on, what content is being appended, and which of their product placements are resonating and which aren't, for example, as illustrated in FIG. 14.

As more and more users use the system to enrich their media-absorption, the system can learn from the consumer behavior, track end-to-end transactions, and recommend exclusive content and vendor offerings through an integrated channel of desktop Internet and handheld devices. The system can be interacted with or through any of the three screens: mobile, PC, television. Additionally, devices such as Blueray players, Xbox/PS-3's, Wii's, 3-G/Smartphones, Set-Top (Cable) boxes, Apple TV's, TiVo's, as well as, standard laptops, PC's and UMPC's are also fully able to engage with the system application. It is envisioned that each of these devices could be distributed with a system gadget loaded on it, thereby allowing the user to activate the system application and experience content according to the present disclosure.

Player Placement

As discussed above, the system Player includes at least three embodiments at the content delivery outlet:

Illustrative embodiments of the Reader can include:
Native Player Interface for operating systems, essentially a ‘Reader & Writer’ that allows the user to interact and add metatags and meta data to a video being viewed;
Third Party Website Player Plug-In, works through open API's that allows for a user to use the system in conjunction with browsers; and
Embedded player Interface in website portal, allowing for enhanced search functions, peer interface and collaboration, rate and recommend, profile management, setting and filter management, etc, also allowing users to store and retrieve media content and associated metadata.

Native Player Interface: An application interface for different native media players that are common in the industry. This player interface includes all the core functionality of a metatag Reader and Author and embeds it into the playback engine. The native player interface is most advantageous for the authoring role where the user can create a media and embed tags at timecode markers by using the native player interface. The basic native player interface can be downloaded from the host site or other channel partners, for example, for free. Certain premium feature sets can be added for an additional charge.

The native playback window can load any Skin from the Internet, for example from the system server, and play the content either invoked by an online transmission handshake from the source of the media or ownloaded with the skin.

Third Party Website Player Plug-In: A playback interface that will be custom built for any web embedded player in a third party site. This plug-in could, for example, carry only the Reader interface and add-in Author interface to existing markers. While the native player interface allows new markers to be added (at the discretion of the content owner) at available timecoded sections of the raw content, the plug-in may be configured to only allows the viewer to add comments, links, and other meta information to existing markers. The plug-in also can be configured to allow the user to save the third party skin to his portal account by one-click action.

If the content creator allows the content to be marker-open (open to adding markers at different timecoded sections), then the user can add markers and tags to new sections of the content by only viewing the third party content through the system portal. This feature will push traffic to the system portal. Special media viewing agreements may be developed with third party media partners for such cross site viewing and content referring from the system site.

The system does not need to save full length media content in the system servers. Content can be delivered through social content websites and other media content hosting websites. However, the system does enable a user to save content in a third party website enabled account while creating a brand new skin for the user's newly generated media content. This feature allows the system to support a network of channel partners who function like content cloud servers for the system. The system Skins can then generate more metatags and henceforth more footprints on a slew of dynamic content hosting sites that will feedback traffic to the system.

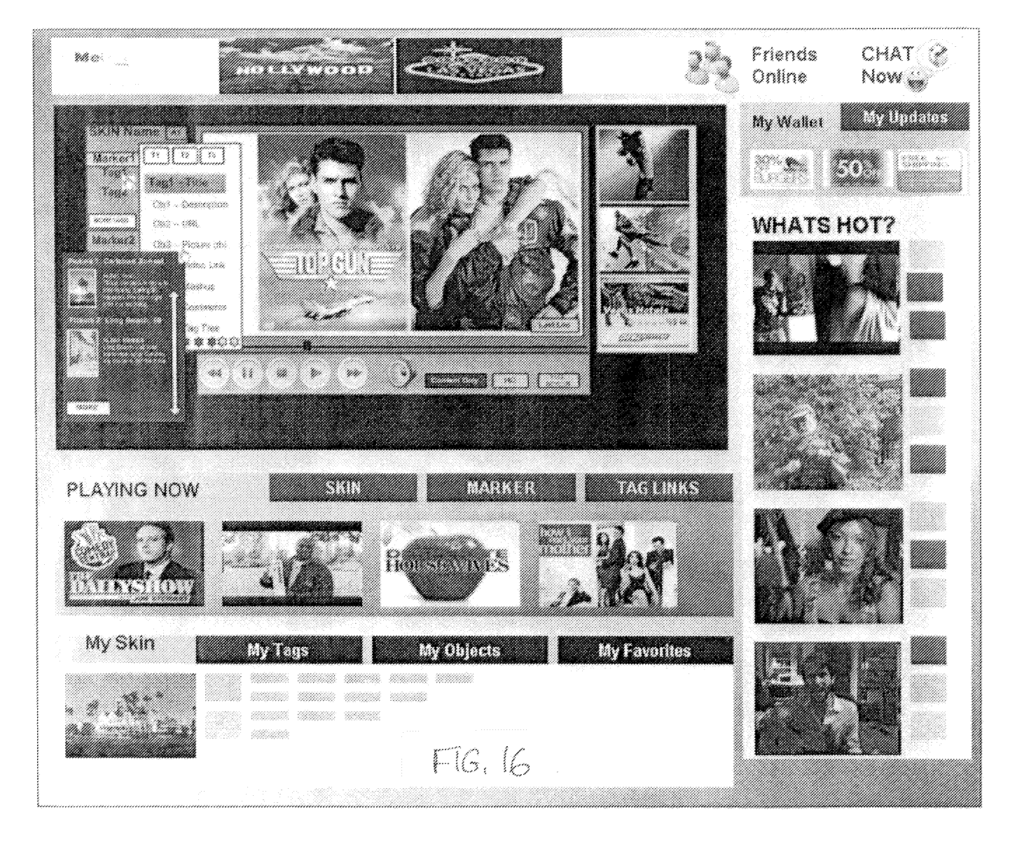

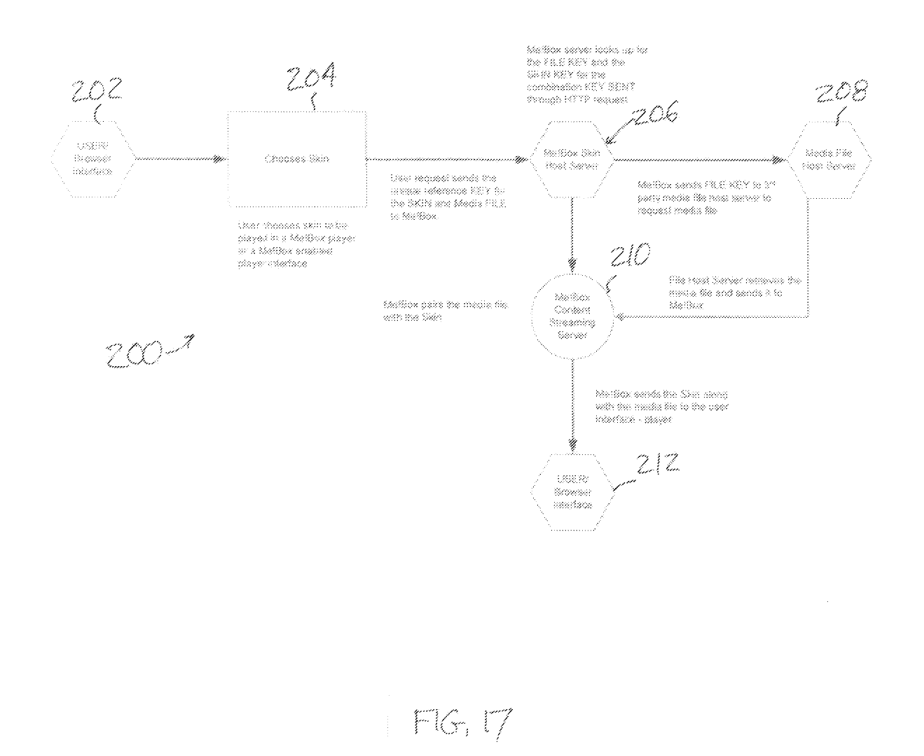

System Portal Embedded Player (PEP) Interface: an integrated interface that brings all the features and components of the system to a single interface, including the Reader, the Author, and an associated web2.0 engine that runs on top of the core media tagger, for example as shown in FIGS. 15 and 16.

The PEP will have all the features of the Native Player Interface from an operational perspective. The additional material in the system player will be the integration with the portal where every marker and the content in the marker become building blocks of the business model due to the skin being able to be shared across individual entities.

The system PEP will allow the account holder to view other account holder's content, syndicated content, and any other branded content from third party sources that have enabled the viewing/playback using the system plug-in in their content sites. In other words, any content that is viewed with a system plug-in in a third party media hosting or providing website like will also be available for viewing through the system portal, with the consent of the content provider. The extra value the PEP gives to other providers and consumers is the ability to convert the Skin into a platform for transactional, social, and referential activities.

Through the PEP a user will be able to add content to existing markers on a Skin (for example, a skin is associated with only one content while one content can be associated with millions of skins), and also be able to add tags, add links, build relationships with brands, and share skins/markers/links with friends and other interested account holders.

The PEP will also allow the account holder to lay a Skin that belongs to other users on a content (that is unique to a skin) and read the metadata, re-experience the metatagged scenes, and gain knowledge from other's inputs or feedback.

System Portal

The System portal is more than just web2.0. The portal is a platform that enables the following features/functionality:

User can view metadata related to a content and save the data for numerous activities:

Gather information;

Follow leads to learn more outside the portal;

Give feedback;

Provide comments or experience tid-bits around the metadata;

Refer the metadata, content, or both;

Share and forward metadata tied to the content;

Grade the available information;

Re-experience elements of the content that has now a different meaning with new information attached to them;

User can search through meta-information, categories of information, and metatags and contents that match the requested niche interest;

User can add URL references or other types of references to a marker or meta information and request other account holders for additional information and feedback;

User can create a whole collage with meta information from different skins across different content and create a hyper-skin that is a mosaic of scene snippets associated to individual markers. Hyper skins are no more associated with a specific content but a aggregate of individual interests that are reflected in user's footprints on different contents. Now think how brands can discover these hyper skins and approach individual users;

Users can be given abilities to connect their other social media interactions (blogs, vlogs, flickr, etc.) with System skins for a one click reference point for sharing across their 2.0 fabric;

The system will also track analytics from portals for behavioral attributes associated with searching, building, sharing, and recommending skins;

The system will extract eCommerce transactions generated from brand created tags with promotions, incentives, and discounts; and

Advanced analytics from the portal activities will be the key elements that brands will buy to understand activities around contents and product placements.

The system can generate revenue various ways, including for example:

Commercial subscriptions;

Added features (plus) for average consumer;

Added features (super) for white label, indie, and semi-pro content producers;

Added features (ultra) for brands, high visibility production houses, and Hollywood;

Premium Author tied with super and ultra subscriptions;

Premium Analytics Tracking;

User Data feeds;

Customized Skins—Premium product placements on highly rated markers (allowing revenue share with skin owners for placing brand messages on markers with high hit ratio);

Behavioral Targeting; and

Commercial content optimization (for example, aligning with certain properties within third-party websites/content/services).

The system may also use functional watermarks, for example at any of the four corners of the screen for user operation purposes. For example, the watermarks can be placed only after the user has read the terms & conditions associated with uploading a content and Skin through a the system interface and agrees to them.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. A system for transforming playable media content, comprising:
a URL associated with a source file containing a selected playable media content;
at least one metadata identifying the URL and including at least one marker;
the at least one marker identifying a contiguous subset of the selected playable media content, and including at least one metatag having information relevant to the content of the playable media at the elapsed time or frame;
a database for storing the metadata, at least one marker, at least one metatag; and
an application including a graphical user interface for accessing the metadata, selected playable media content, at least one marker, and metatag, and simultaneously displaying the playable media content and the associated metatag information in accordance with the at least one marker.

2. The system of claim 1, further comprising:
a wide area network (WAN);
a first server storing the database and connected to the WAN;
a second server storing the source file containing the selected media content and connected to the WAN; and
a display device including a programmable processor connected to the WAN, the application enabling the simultaneous displaying on the display device.

3. The system of claim 2, wherein the contiguous subset at least one of a time domain and a frame domain.

4. The system of claim 3, wherein the marker is associated with an object within a continuous subset of video frames.

5. The system of claim 3, wherein the marker identifying the at least one contiguous subset includes at least a defined display area within one or more contiguous video frames.

6. The system of claim 2, further comprising:
information relating to users of the application stored in the database, the information including a user's association with an at least one marker; and
the application enabling users to identify and exchange information with another user based on a user's association with an at least one marker.

7. The system of claim 2, wherein the creation, editing, and deletion of the metadata, the at least one marker, and the at least one metatag requires no modification to the source file containing the selected playable media content.

8. The system of claim 2, wherein at least one of the at least one metadata and at least one metatag include at least one label searchable by the application.

9. The system of claim 2, wherein at least one of the at least one metadata and at least one metatag include a wiki on/off indicator for alternatively enabling or disabling the application to wiki the at least one meta data and metatag.

10. The system of claim 2, wherein at least one of the at least one metadata and at least one metatag includes information regarding intellectual property rights relating to the associated media content.

11. The system of claim 2, wherein the at least one metatag includes one of media content, opinion, factual information, promotional information, or URL link.

12. The system of claim 2, wherein the at least one metatag can be associated with more than one metadata, including metadata associated with different selected playable media contents.

13. A processor readable storage medium storing a processor executable module which when executed on a display device having a programmable processor, directs the processor to:
transform the display of playable media content based on a plurality of metatags, each metatag being associated with a particular segment of the media content;
provide user interfaces to control the playing, pausing, forwarding, and reversing of the playable media content;
provide a first display area for the playable media content; and
provide a second display area for features associated with the plurality of metatags.

14. The processor readable storage medium storing the processor executable module of claim 13, further providing user interfaces to selectively access features associated with each of the plurality of metatags.

15. The processor readable storage medium storing the processor executable module of claim 13, further providing:
storage of features associated with the metatag; and,
transmission of the features to another display device in response to a user selection.

16. The processor readable storage medium storing the processor executable module of claim 13, wherein the second display area includes a user selectable subset of metatag features associated with a presently playing segment of the media content, a user selectable subset of metatag features associated with a prior played segment of the media content, and a user selectable subset of metatag features associated with an upcoming segment of the media content.

17. The processor readable storage medium storing the processor executable module of claim 13, each particular segment defined by a marker associated with at least one of elapsed time and frame of the media content, and each metatag is associated with a marker.

18. The processor readable storage medium storing the processor executable module of claim 13, further providing:
user creation of at least one metadata identifying a source file for the selected media content;
user creation of at least one marker associated with the at least one metadata, the at least one marker identifying a contiguous subset of the selected media content;
user creation of the plurality of metatags, each of the plurality of metatags associated with at least one of the at least one marker and having information relevant to the content of the media at an elapsed time or frame; and
user upload of the at least one metadata, at least on marker, and plurality of metatags to a server for later access by one or more users.

19. The processor readable storage medium storing the processor executable module of claim 18, further providing capture and storage on the server a snippet of content beginning from the position of a marker as a thumbnail or preview.

20. The processor readable storage medium storing the processor executable module of claim 18, further providing receipt of confirmation from the user creating the metatag that the user holds sufficient intellectual property rights in the features of the metatag.

21. A system for transforming the display of playable media content, comprising:
a database server including:
a plurality of marker sets wherein each marker set includes at least one marker, each marker set associated with a specific media content file accessible via the Internet, and
a plurality of metatag features, each metatag feature associated with at least one marker;
a first module associated with the database server for receiving a request from a client computer;
a second module associated with the database server for transmitting a marker set to the client in response to the request; and,
a third module associated with the database server for receiving and recording information about the metatag features selected at the client computer.

22. A system for transforming the display of playable media content of claim 21, wherein the first module is capable of selecting one of the plurality of marker sets that are associated with the specified playable media content file, and the second module is capable of transmitting to the client a URL associated with the specified media content file.
